(19) United States
(12) Patent Application Publication
(10) Pub. No.: US 2025/0242254 A1
(43) Pub. Date: Jul. 31, 2025

(54) STORAGE MEDIUM, INFORMATION PROCESSING SYSTEM, INFORMATION PROCESSING APPARATUS, AND INFORMATION PROCESSING METHOD

(71) Applicant: NINTENDO CO., LTD., Kyoto (JP)

(72) Inventors: Tatsuya KURIHARA, Kyoto (JP); Ryo KAWASAKI, Kyoto (JP)

(21) Appl. No.: 19/040,545

(22) Filed: Jan. 29, 2025

(30) Foreign Application Priority Data
Jan. 30, 2024 (JP) 2024-011605

(51) Int. Cl. A63F 13/57

(52) U.S. Cl. CPC A63F 13/57

(57) ABSTRACT

An example of an information processing system sets, as a return point, a position inside or in the vicinity of a return area in the game stage, based on at least the player object having reached the return area. The information processing system changes the shape of a terrain object in the game stage according to a motion, of the player object, based on a first operation input performed by the player. According to a second operation input performed by the player, the information processing system restores the terrain object whose shape has been changed, to the shape before the change and before a timing at which the return point was set. According to the second operation input, the information processing system moves the player object to the return point in a state where at least a part of states represented by the player information is maintained.

### CROSS REFERENCE TO RELATED APPLICATION

This application claims priority to Japanese Patent Application No. 2024-011605, filed on Jan. 30, 2024, the entire contents of which are incorporated herein by reference.

### FIELD

The present disclosure relates to a storage medium, an information processing system, an information processing apparatus, and an information processing method for executing a game in a game space including a terrain object that can be changed.

### BACKGROUND AND SUMMARY

Conventionally, there is a game in which a terrain object in a game space can be changed by a player operation during the game.

Conventionally, if the terrain object changed during the game as described above is reset to an initial state, game states such as items possessed by a player character are also reset. Therefore, it is desired to improve convenience in the case of resetting a terrain object.

Therefore, the present application discloses a storage medium, an information processing system, an information processing apparatus, and an information processing method capable of improving convenience in the case of setting a terrain object.

(1)

An example of one or more non-transitory computer-readable storage medium having stored therein instructions that, when executed, cause one or more processors of an information processing apparatus to execute information processing comprising: updating a progress state of a game that is progressed by controlling a player object according to an operation input performed by a player in a game stage in a virtual space; automatically storing, in a storage medium, player information that is associated with the player object and changes according to the progress state of the game; setting, as a return point, a position inside or in the vicinity of a return area in the game stage, based on at least the player object having reached the return area; changing a shape of a terrain object in the game stage according to a motion, of the player object, based on a first operation input performed by the player; according to a second operation input performed by the player, restoring the terrain object whose shape has been changed, to the shape before the change and before timing at which the return point was set; and according to the second operation input, moving the player object to the return point in a state where at least a part of states represented by the player information is maintained.

According to the configuration of the above (1), when the terrain object is restored according to the second operation input performed by the player, at least a part of the states of the player object that change according the progress state of the game is maintained, whereby convenience in the case of resetting the terrain object can be improved.

(2)

In the configuration of the above (1), the information processing may further comprise: at start of the game in the game stage, generating the terrain object, based on reference terrain information representing a reference shape of the terrain object in the game stage; and according to the second operation input, restoring the shape of the terrain object having been changed, based on the reference terrain information.

According to the configuration of the above (2), the terrain object can be restored so as to reflect the shape at the start of the game.

(3)

In the configuration of the above (1) or (2), restoration of the shape of the terrain object and movement of the player object to the return point may be performed according to the second operation input without consuming any currency and item used in the game.

According to the configuration of the above (3), the player can perform the second operation input without or almost without disadvantages in the game, whereby convenience in the case of resetting the terrain object can be further improved.

(4)

In the configuration of the any one of above (1) to (3), restoration of the shape of the terrain object and movement of the player object to the return point may be performed according to the second operation input, regardless of the progress state of the game.

According to the configuration of the above (4), the player can perform the second operation input regardless of the progress state of the game, and therefore can easily reset the terrain object.

(5)

In the configuration of the any one of above (1) to (4), according to the second operation input, the player object may be moved to the return point, in a state where at least one of: information representing the progress state of the game; information representing hit points of the player object; and information representing conditions and/or the number of items possessed by the player object, is maintained among the states represented by the player information.

According to the configuration of the above (5), the terrain object can be restored while maintaining the state of the player character represented by the above information, whereby convenience in the case of resetting the terrain object can be further improved.

(6)

In the configuration of the any one of above (1) to (5), the shape of the terrain object may be changed by deleting the terrain object or making an addition to the terrain object, according to the motion of the player object based on the first operation input.

According to the configuration of the above (6), the player can change the shape of the terrain object by deleting or making an addition to the terrain object.

(7)

In the configuration of the any one of above (1) to (6), the terrain object may include an object that is not deleted by the motion of the player object based on the first operation input.

According to the configuration of the above (7), the possibility of inconvenience in the game can be reduced.

(8)

In the configuration of the any one of above (1) to (7), according to the second operation input, the player object may be moved to a return point that has been set last, among set return points.

According to the configuration of the above (8), the player can resume the game from the position where the player can easily progress the game, whereby convenience for the player can be improved.

(9)

In the configuration of the any one of above (1) to (8), the terrain object may include a first terrain object and a second terrain object. According to the second operation input, a property and a shape of the first terrain object may be restored, and a shape of the second terrain object may be restored with a property thereof being changed.

According to the configuration of the above (9), it is possible to reduce the possibility of inconvenience that is caused by the property of the terrain object being maintained when the terrain object is restored.

(10)

In the configuration of the above (9), the property of the second terrain object before the restoration is performed may be that a reward is given to the player object when the second terrain object is deleted according to a motion of the player object based on the first operation input. According to the second operation input, the property of the second terrain object may be changed to: a property that a reward is not given to the player object even when the second terrain object is deleted according to the motion of the player object based on the first operation input; or a property that a reward less than that before the change is given to the player object when the second terrain object is deleted according to the motion of the player object based on the first operation input.

According to the configuration of the above (10), it is possible to reduce the possibility that too much reward is given to the player object due to restoration of the terrain object.

(11)

In the configuration of the any one of above (1) to (10), according to an automatic restoration condition having been satisfied, the shape of the terrain object in a predetermined area in the game stage may be automatically restored even when the second operation input is not performed. According to the automatic restoration condition having been satisfied, the player object may be automatically moved to the return point even when the second operation input is not performed.

According to the configuration of the above (11), it is possible to reduce the possibility of trouble in game processing or inconvenience in game progress.

(12)

In the configuration of the above (11), according to the automatic restoration condition having been satisfied, the shape of the terrain object in the predetermined area may be automatically restored, while the shape of the terrain object outside the predetermined area is not restored. According to the second operation input, both the shape of the terrain object inside the predetermined area and the shape of the terrain object outside the predetermined area may be restored.

According to the configuration of the above (12), the player can manually restore the terrain object, and it is possible to reduce the possibility of inconvenience in the game when the terrain object is automatically restored.

(13)

In the configuration of the above (11) or (12), the automatic restoration condition may be that the player object has satisfied a game over condition. The predetermined area may include: the return point at which the player object is placed after the player object has satisfied the game over condition; and an area surrounding the return point.

According to the configuration of the above (13), it is possible to reduce the possibility of inconvenience when the player object is placed at the return point.

(14)

In the configuration of the above (11) or (12), the automatic restoration condition may be that the player object has satisfied a game over condition during a battle against a predetermined enemy object. The predetermined area may include an area, in the game stage, in which the battle against the enemy object is performed.

According to the configuration of the above (14), it is possible to reduce the possibility of inconvenience that the battle against the enemy object is significantly disadvantageous for the player object.

(15)

In the configuration of the any one of above (11) to (14), the predetermined area may be set for each of unit sections defined in the game stage.

According to the configuration of the above (15), since the terrain object can be restored for each unit section, the restoration process can be efficiently performed.

(16)

In the configuration of the above (11), the information processing may further comprise: monitoring a usage rate of a memory of the information processing apparatus. The automatic restoration condition may be a condition regarding the usage rate of the memory.

According to the configuration of the above (16), it is possible to reduce the possibility of trouble in game processing due to memory shortage.

(17)

In the configuration of the any one of above (1) to (16), the storage medium may store therein instructions that, when executed by the processor of the information processing apparatus, cause the information processing apparatus to further perform operations comprising: causing a display device to display a map image which represents the game stage and in which change in the shape is reflected; and receiving the second operation input in a state where the map image is being displayed.

According to the configuration of the above (17), the player can determine whether or not to perform the second operation input while checking the current state of the terrain object, whereby convenience for the player can be further improved.

(18)

In the configuration of the any one of above (1) to (17), when the player object has left the game stage without satisfying a clear condition set for the game stage, a content of at least a part of the player information may be restored to the content before the player object enters the game stage.

According to the configuration of the above (18), it is possible to make the game more advantageous for the player in the case of performing the second operation input than in the case of causing the player object to leave the game stage.

Note that the present specification discloses examples of an information processing apparatus and an information processing system that execute the processes in the above (1) to (18). Further, the present specification discloses an example of an information processing method that executes the processes in the above (1) to (18).

According to the storage medium, the information processing system, the information processing apparatus, or the information processing method described above, convenience in the case of resetting a terrain object can be improved.

These and other features, aspects and advantages of subject matter described herein will become more apparent from the following detailed description when taken in conjunction with the accompanying drawings.

### BRIEF DESCRIPTION OF THE DRAWINGS

FIG. 1 is a view showing an example where a non-limiting left controller and a non-limiting right controller are attached to a non-limiting main body apparatus;

FIG. 2 is a view showing an example where a non-limiting left controller and a non-limiting right controller are removed from a non-limiting main body apparatus;

FIG. 3 is a six-sided view showing an example of a non-limiting main body apparatus;

FIG. 4 is a six-sided view showing an example of a non-limiting left controller;

FIG. 5 is a six-sided view showing an example of a non-limiting right controller;

FIG. 6 is a block diagram showing an example of an internal configuration of a non-limiting main body apparatus;

FIG. 7 is a block diagram showing an example of an internal configuration of a non-limiting main body apparatus, a non-limiting left controller and a non-limiting right controller;

FIG. 8 is a view showing an example of a terrain object, which is a voxel object;

FIG. 9 is a view showing before and after the deletion of a portion of the terrain object shown in FIG. 8;

FIG. 10 is a view showing before and after the deletion of a portion of the terrain object shown in FIG. 8;

FIG. 11 is a diagram showing an example of content of voxel data and content of material information;

FIG. 12 is a diagram showing an example of property information representing properties of materials;

FIG. 13 is a diagram showing an example of texture information representing textures of materials;

FIG. 14 is a diagram showing a method for generating a mesh;

FIG. 15 is a view showing an example of a game image including a terrain object;

FIG. 16 is a diagram showing an example of change when terrain reset has been performed;

FIG. 17 is a diagram showing an example of a map image displayed on a display device;

FIG. 18 is a diagram showing an example of a game image representing a terrain object in a reference state;

FIG. 19 is a diagram showing an example of a game image representing a state where a portion of a terrain object has been deleted by a player character;

FIG. 20 is a diagram showing an example of a game image representing a state where a terrain resetting input has been performed after the state shown in FIG. 19;

FIG. 21 is a diagram illustrating an outline of restoration of a terrain object in a target area;

FIG. 22 is a diagram showing an example of a state where a terrain object is added in the vicinity of a check point;

FIG. 23 is a diagram showing an example of a state where a terrain object in a target area including a return point is restored;

FIG. 24 is a diagram showing an example of various data used for information processing in a non-limiting game system;

FIG. 25 is a flowchart showing an example of a flow of a game stage process executed by the non-limiting game system; and

FIG. 26 is a flowchart showing an example of a flow of a map display process executed by the non-limiting game system.

### DETAILED DESCRIPTION OF NON-LIMITING EXAMPLE EMBODIMENTS

### [1. Configuration of Game System]

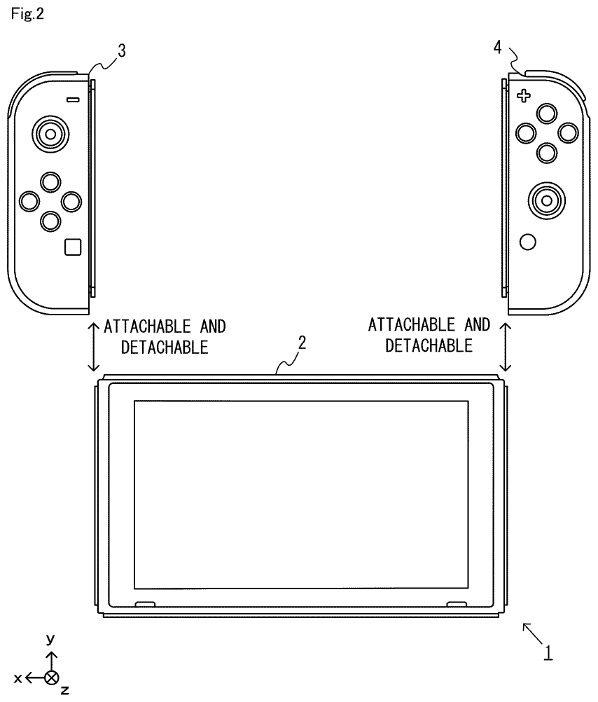

A game system according to an example of an exemplary embodiment is described below. An example of a game system 1 according to the exemplary embodiment includes a main body apparatus (an information processing apparatus; which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the exemplary embodiment is described, and then, the control of the game system 1 according to the exemplary embodiment is described.

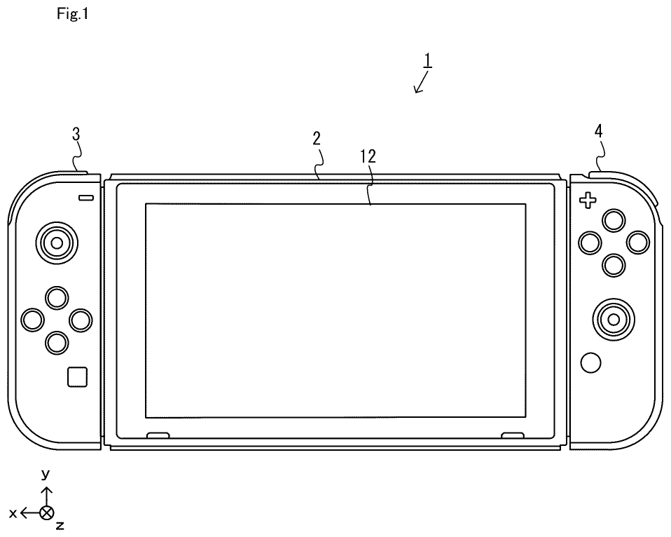

FIG. 1 is a diagram showing an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram showing an example of the state where each of the left controller 3 and the right controller 4 is detached from the main body apparatus 2. As shown in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

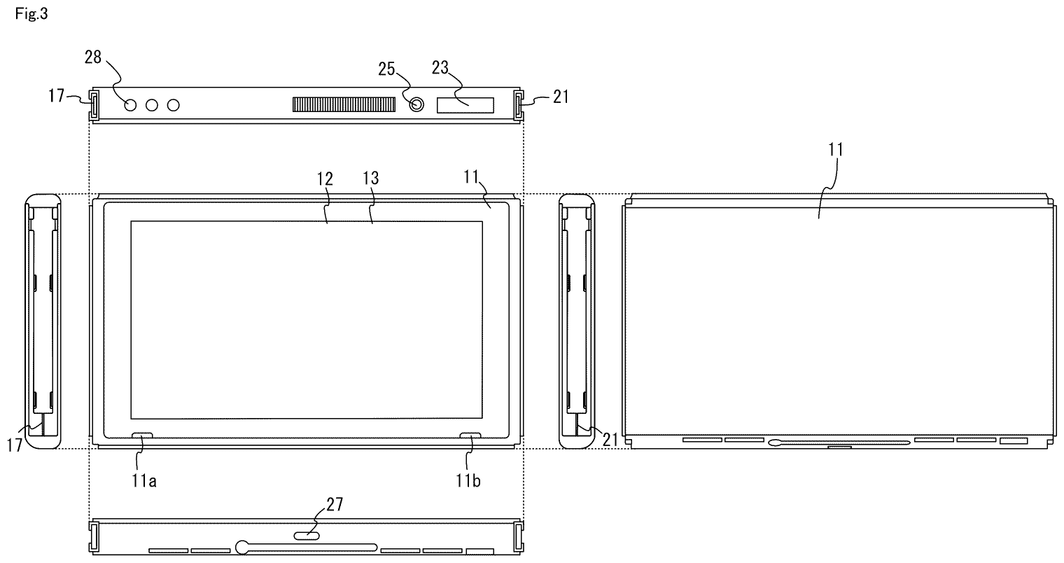

FIG. 3 is six orthogonal views showing an example of the main body apparatus 2. As shown in FIG. 3, the main body apparatus 2 includes an approximately plate-shaped housing 11. In the exemplary embodiment, a main surface (for example, a surface on a front side, such as a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

Further, the main body apparatus 2 includes a touch panel 13 on a screen of the display 12. In the exemplary embodiment, the touch panel 13 is of a type that allows a multi-touch input (e.g., a capacitive type). The touch panel 13, however, may be of any type. For example, the touch panel 13 may be of a type that allows a single-touch input (e.g., a resistive type).

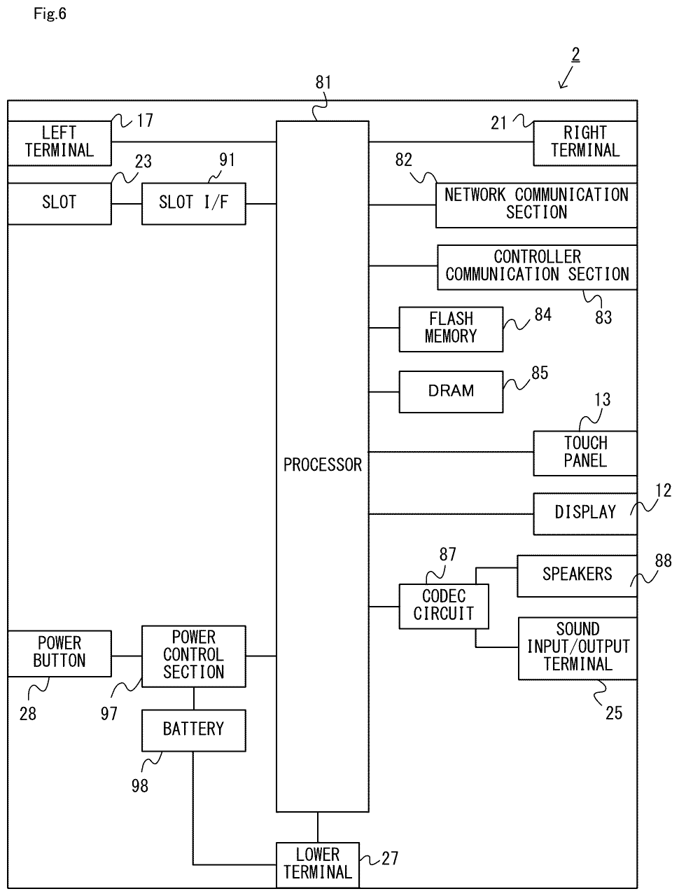

The main body apparatus 2 includes speakers (e.g., speakers 88 shown in FIG. 6) within the housing 11. As shown in FIG. 3, speaker holes 11a and 11b are formed on the main surface of the housing 11. Then, sounds output from the speakers 88 are output through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game system 1 can display on a monitor an image generated by and output from the main body apparatus 2. The monitor may be stationary or may be movable. Further, in the exemplary embodiment, the cradle has the function of charging the unified apparatus or the main body apparatus 2 alone mounted on the cradle. Further, the cradle has the function of a hub device (specifically, a USB hub).

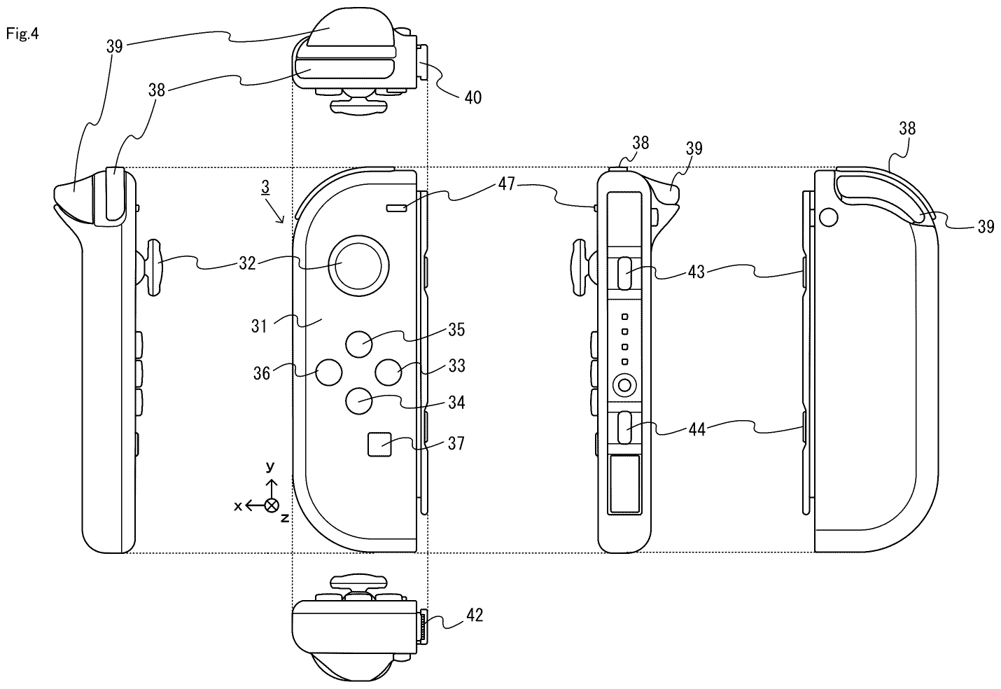

FIG. 4 is six orthogonal views showing an example of the left controller 3. As shown in FIG. 4, the left controller 3 includes a housing 31. In the exemplary embodiment, the housing 31 has a vertically long shape. The housing 31 may be shaped to be long in an up-down direction. For example, along the y-axis direction shown in FIGS. 1 and 4. In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As shown in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the exemplary embodiment, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an operating system (OS) program and an application program) executed by the main body apparatus 2.

Further, the left controller 3 includes a terminal 42 for the left controller 3 to perform wired communication with the main body apparatus 2.

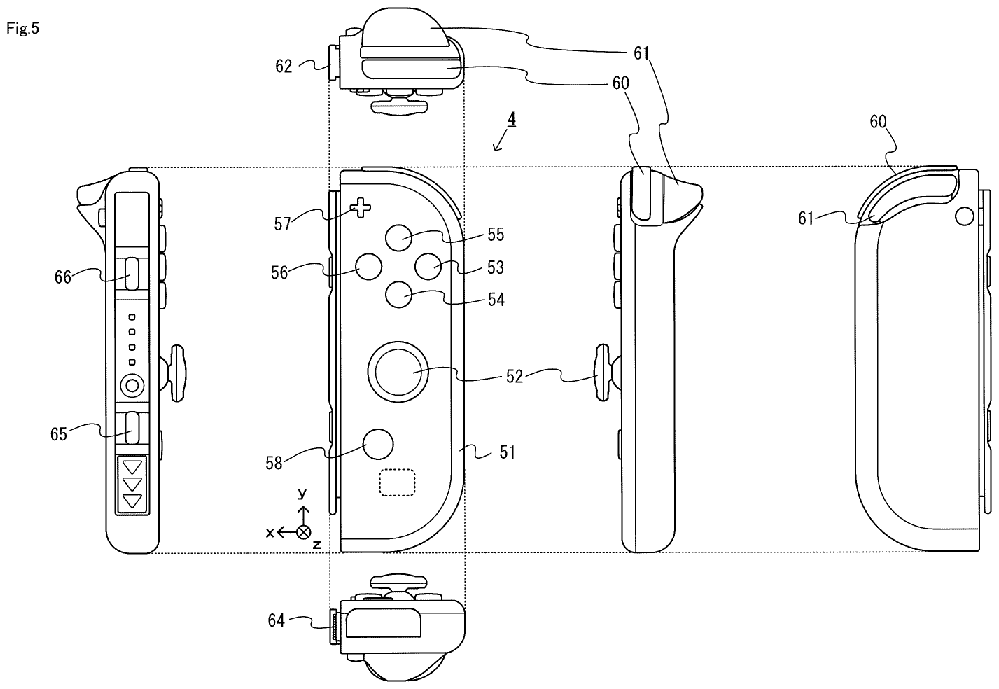

FIG. 5 is six orthogonal views showing an example of the right controller 4. As shown in FIG. 5, the right controller 4 includes a housing 51. In the exemplary embodiment, the housing 51 has a vertically long shape. For example, it may be shaped to be long in the up-down direction. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the exemplary embodiment, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 85, 87, 88, 91, 97, and 98 shown in FIG. 6 in addition to the components shown in FIG. 3. Some of the components 81 to 85, 87, 88, 91, 97, and 98 may be mounted as electronic components on an electronic circuit board and accommodated in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) or other instructions that are stored in storage. For example, in an internal non-transitory storage medium such as a flash memory 84, an external non-transitory storage medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing. The DRAM 85 and flash memory 84 are illustrative non-limiting examples of non-transitory computer-readable media.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is optional. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). Based on a command from the processor 81, the power control section 97 controls the supply of power from the battery 98 to the above components.

Further, the battery 98 is connected to the lower terminal 27. When an external charging device (e.g., the cradle) is connected to the lower terminal 27, and power is supplied to the main body apparatus 2 via the lower terminal 27, the battery 98 is charged with the supplied power.

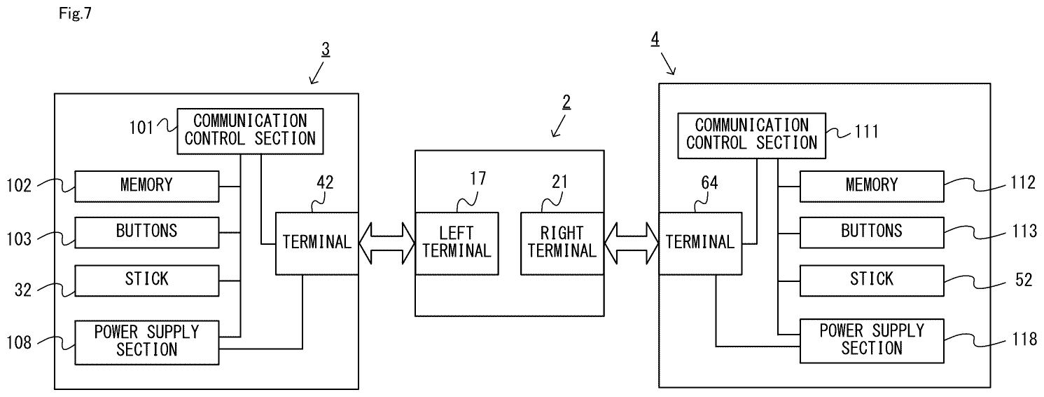

FIG. 7 is a block diagram showing examples of the internal configurations of the main body apparatus 2, the left controller 3, and the right controller 4. It should be noted that the details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 acquires information regarding an input (specifically, information regarding an operation or the detection result of the sensor) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108. [2. Outline of process on game system]

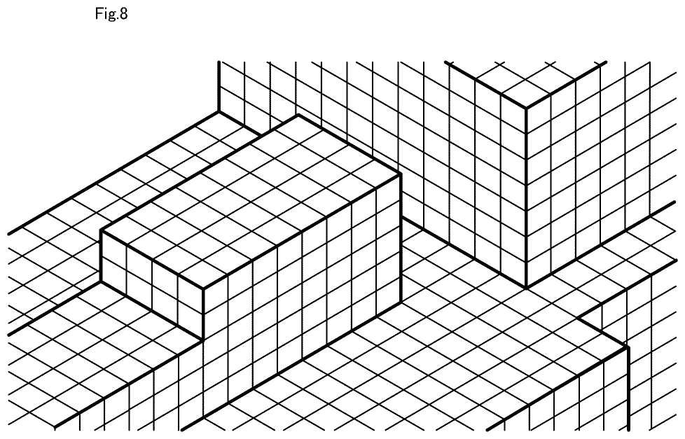

Next, referring to FIG. 8 to FIG. 21, an outline of the process performed on the game system 1 will be described. In the exemplary embodiment, the game system 1 generates a game image in which terrain objects and characters (e.g., the player character controlled by the player) are arranged in a game space, which is a three-dimensional virtual space, and displays the game image on a display device. Note that in the exemplary embodiment, the display device on which the game image is displayed may be the display 12 described above, or may be a stationary monitor.

### [2-1. Voxel]

In the exemplary embodiment, for some objects in the game space, the shape is defined by voxel data. Here, voxels are rectangular parallelepiped (more specifically, cubic) regions arranged in a grid pattern in the game space, and voxel data is data that is set for each voxel. Hereinafter, an object whose shape is defined by voxel data will be referred to as a “voxel object”. In the exemplary embodiment, the game system 1 stores voxel data for each of a plurality of voxels that are set in the game space as data for generating voxel objects in the game space.

FIG. 8 is a view showing an example of a terrain object, which is a voxel object. As shown in FIG. 8, in the exemplary embodiment, a terrain object representing a terrain such as a ground surface has its shape defined by voxel data. The cubes shown in FIG. 8 represent a terrain object. Note that in FIG. 8, edges of the terrain object are indicated by thick lines. However, these thick lines are added for the purpose of making the drawings easier to understand, and there is no need for edges of the terrain object to be drawn thick.

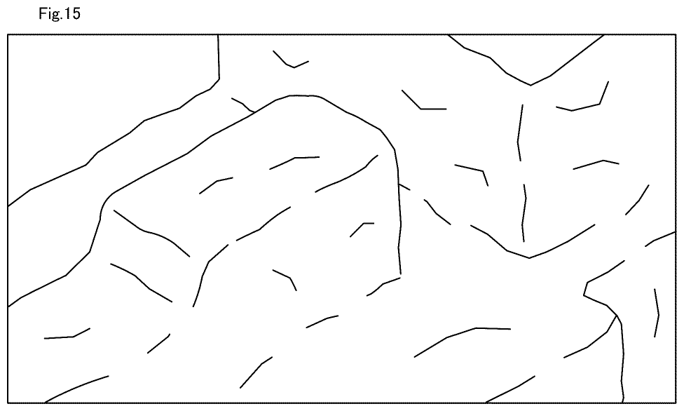

For example, the terrain object shown in FIG. 8 is generated by the following rule: “a cube is placed at the position of a voxel if a parameter included in the voxel data set for the voxel is greater than a predetermined value, and nothing is placed at the position of the voxel if the parameter is less than or equal to the predetermined value”. A terrain object in FIG. 8 is shown for the purpose of illustrating the relationship between voxels and voxel objects in an easy-to-understand manner. Note that in the exemplary embodiment, in practice, a voxel object is generated (e.g., based on voxel data) by such a rule that results in a terrain object having a complicated shape in comparison with the cubic voxels, such as a terrain object shown in FIG. 15 to be described below, for example. Note that there is no limitation on the rule for determining the shape of the voxel object based on the voxel data. In other embodiments, the game system 1 may generate a voxel object as shown in FIG. 8 based on the object data or may generate a voxel object as shown in FIG. 15 based on the object data.

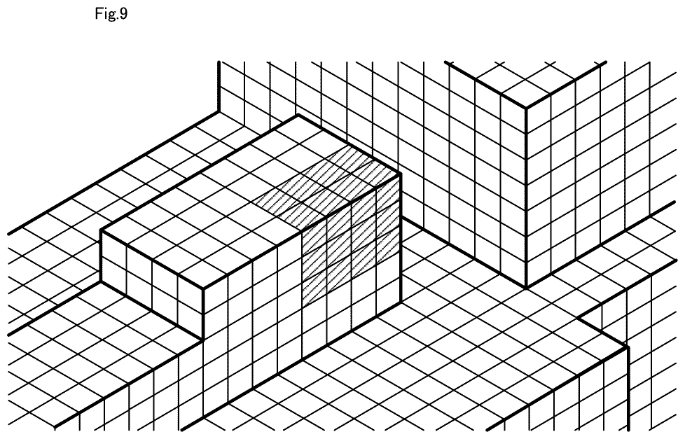

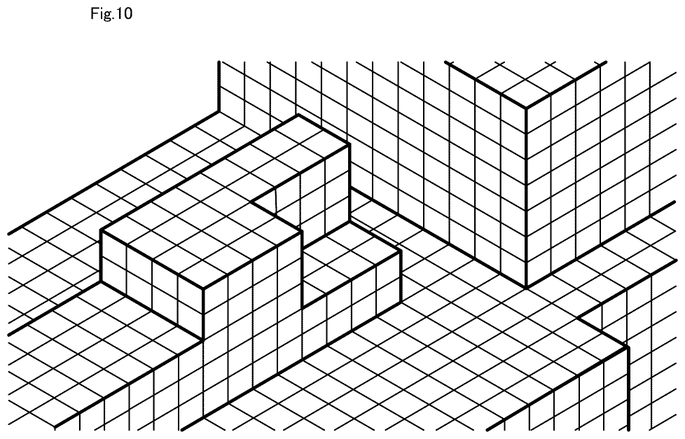

It is possible to change the shape of a voxel object by changing voxel data of voxels. FIG. 9 and FIG. 10 are views showing before and after the removal of a portion of the terrain object shown in FIG. 8. That is, when the hatched portion of the terrain object shown in FIG. 9 is broken, the terrain object changes to a shape as shown in FIG. 10. In such a case, the game system 1 can easily delete the terrain object by rewriting the voxel data described below so as to indicate that the terrain object is absent for voxels in the hatched portion. Note that also when making an addition to the terrain object, as when deleting the terrain object, the game system 1 can easily change the shape of the terrain object by changing the voxel data of voxels.

Thus, the game system 1 can freely change the shape of a voxel object by rewriting the voxel data. For example, the shape of a terrain object may be changed as a result of the terrain object in a game being broken for some reason (e.g., the player object striking the terrain object). In such a case, the game system 1 can freely change the shape of the terrain object by changing the voxel data used to generate the terrain object, rather than directly changing data representing the outer shape of the terrain object (e.g., the mesh to be described below).

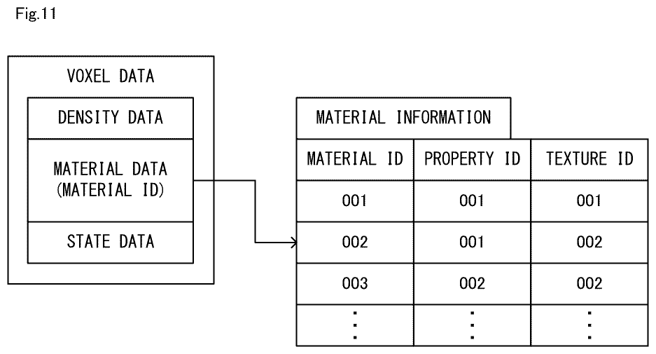

FIG. 11 is a diagram showing an example of content of voxel data. Here, in the exemplary embodiment, the game space can be divided into a plurality of voxels arranged in a grid pattern. The game system 1 stores voxel data for each voxel in the game space so that the voxel data is associated with the voxel. The voxel data represents, for example, the presence/absence of a voxel object in the voxel corresponding to the voxel data.

As shown in FIG. 11, voxel data includes density data. The density data represents the density, which is an index used to define the shape of a voxel object in the voxel corresponding to the voxel data (specifically, the shape defined by the mesh to be described below). As will be described in detail below, the position and the shape of the surface of the voxel object (e.g., the mesh to be described below) are determined based on this density. In other words, in the exemplary embodiment, this density is used to generate a mesh that defines the surface of the voxel object.

In the exemplary embodiment, the density can take an integer value in the range from the lower limit value (e.g., 0) to the upper limit value (e.g., 255). In the exemplary embodiment, the game system 1 determines the shape of a voxel object based on the density such that the proportion of the volume to be occupied by the voxel object in a voxel tends to be higher when the density value set for the voxel is higher and that the proportion tends to be lower when the density value is lower. Thus, the density is an index that affects the proportion of the volume to be occupied by the voxel object in the voxel. The density can also be said to be an index that represents the degree to which an object is included in the region defined by each voxel. For example, if the density is 0, there is no voxel object in the voxel, if the density is 255, the inside of the voxel is entirely the voxel object, and if the density is between 0 and 255, the inside of the voxel is occupied by the voxel object to the proportion that is determined based on the density value. Then, the shape of the mesh, e.g., the shape of the voxel object, can determined based on the density. Note however that the voxel object generated based on the density does not need to have a volume that exactly matches the proportion represented by the density. For example, the method of generating a voxel object as shown in FIG. 8 and the method of generating a voxel object as shown in FIG. 15 may differ in the volume of the voxel object, even if they are based on the same density.

In other embodiments, the density may indicate either a state in which the voxel object occupies the entirety of the region within the voxel or a state in which no voxel object is included in the region within the voxel. For example, the density data may be data that can take only 0 or 1.

As shown in FIG. 11, voxel data includes material data. The material data represents the material (in other words, the substance) of the voxel object generated by the voxel data. Here, in the exemplary embodiment, materials such as sand, rock and soil, for example, are set for voxel objects. That is, in the exemplary embodiment, a plurality of types of materials are provided as materials that can be set for a voxel object, and one of the materials is set for a voxel object.

As shown in FIG. 11, in the exemplary embodiment, the material data represents the identification information of the material (referred to as “material ID”). In the exemplary embodiment, the game system 1 stores material information representing the property and the texture of the material for each material provided in the game. In the exemplary embodiment, the material information represents associations between the material ID, the property of the material and the appearance (specifically, the texture) of the material. Specifically, the material information is information that represents associations between the material ID, identification information of the property of the material (referred to as “property ID”) and identification information of the texture of the material (referred to as “texture ID”) (see FIG. 11).

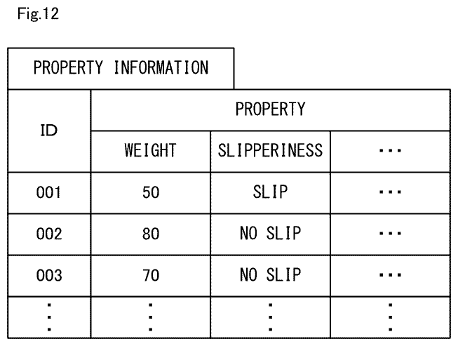

FIG. 12 is a diagram showing an example of property information representing properties of materials. As shown in FIG. 12, the game system 1 stores property information that associates each property ID with information that represents the content of the property represented by the property ID. A property of a material is a property of a voxel object for which the material is set in the game, and it may be information such as weight or slipperiness shown in FIG. 12, for example. Note that there is no limitation on the specific content of property. For example, the following information may be set as properties of a material.
Temperature
Breakability (e.g., the number of times of impact impartation needed to break a voxel object)
Whether another object can be bonded to a voxel object
Amount of hit points to be regained by the player character when the player character breaks a voxel object
Amount of in-game currency to be gained by the player character when the player character breaks a voxel object

Note that there is no limitation on the specific content of the property to be set for a material. In other embodiments, information different from those listed above may be set as information that represents a property of a material.

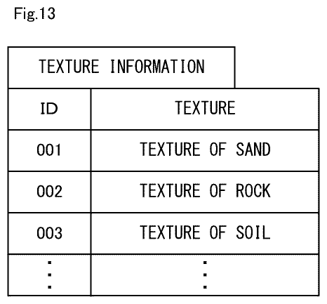

FIG. 13 is a diagram showing an example of texture information representing textures of materials. As shown in FIG. 13, the game system 1 stores texture information that associates the texture ID with the texture represented by the texture ID.

Note that in addition to information of texture, any information regarding the color and/or pattern may be set as data that defines the appearance of a voxel object. For example, a pattern of cracks may be set as information regarding the appearance of a voxel object. By using such a pattern, the game system 1 can generate an image of a voxel object that represents the appearance of cracks.

As described above, in the exemplary embodiment, the material data defines, by the material ID, the property of the voxel object and the texture used for the voxel object. For example, when the material ID represented by the material data included in the voxel data is “002”, the property represented by the property ID “001” that is associated with the material ID in the material information is set as the property of the voxel object corresponding to the voxel data (see arrow shown in FIG. 11). In this case, the texture that is represented by the texture ID “002” associated with the material ID in the material information is applied to the voxel object corresponding to the voxel data (see arrow shown in FIG. 11).

As described above, in the exemplary embodiment, the game system 1 separately manages the property and the texture of the material. Therefore, in the exemplary embodiment, it is possible to easily set a plurality of types of materials having the same property but having different appearances (e.g., different textures) or set a plurality of types of materials having different properties but having the same appearance.

Note that the material data may be any data with which it is possible to identify the property and/or the texture of the material. For example, in other embodiments, the material data may represent the property ID and the texture ID, or may have a data structure that actually includes data representing the property and the texture of the material.

The material data may further represent information related to the material other than the property and the texture described above. For example, the material data may include special effect data that represents the special effect to be triggered upon satisfaction of a special effect triggering condition set for the voxel object (e.g., a portion of the voxel object being broken, or the character stepping on the voxel object). Note that the special effect data may be data that represents a special effect image (e.g., a special effect image showing the voxel object being broken), or may be data that represents a special effect sound (a sound of footstep when the character walks on the voxel object).

As shown in FIG. 11, the voxel data includes state data that represents the state of the voxel object. There is no limitation on the specific content of the state data. For example, the state data may be data that represents whether the voxel object is in a wet state, or may be data that represents the amount of damage applied to the voxel object. The content of the state data may be updated during the game.

### [2-2. Mesh]

In the exemplary embodiment, the surface of the voxel object is represented by a mesh. A mesh is a set of faces (specifically, polygons) placed in the game space. In the exemplary embodiment, the game system 1 generates a mesh for the voxel object based on the voxel data of each voxel set in the game space. An example of how a mesh is generated based on voxel data will now be described.

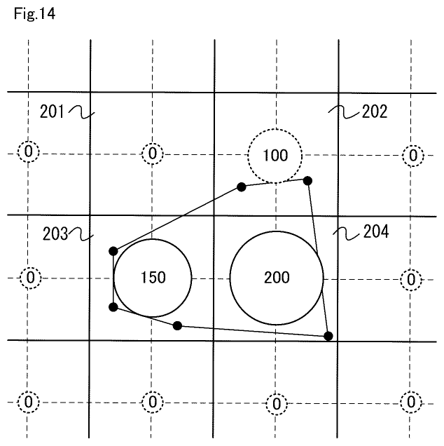

FIG. 14 is a diagram showing an example method for generating a mesh. Note that in FIG. 14, voxels and meshes are represented in two dimensions for the purpose of making the drawing easier to understand and for the sake of discussion, but in practice, a three-dimensional mesh is generated based on voxels in a three-dimensional space.

As described above, in the exemplary embodiment, the density set for the voxel is in the range of 0 to 255. In the exemplary embodiment, voxels with densities equal to or greater than the reference threshold value are considered to be inside the voxel object, and voxels with densities less than the reference threshold value are considered to be outside the voxel object. It is not necessary to define only voxels with a density of 0 as being outside the voxel object (e.g., reference threshold value=1), and the reference threshold value may be set to 128, for example. In the example shown in FIG. 14, a voxel 201 and the other outer voxels have a density of 0, a voxel 202 has a density of 100, which is less than the reference threshold value, and voxels 203 and 204 have densities of 150 and 200, which are greater than the reference threshold value (e.g., 128). In the exemplary embodiment, the game system 1 generates vertices between those voxels whose densities are equal to or greater than the reference threshold value and those voxels whose densities are less than the reference threshold value. Specifically, for each region (region delimited by dotted lines) that straddles eight (four in the figure) adjacent voxels, it is determined whether or not to generate a vertex. That is, a vertex is generated in each region that straddles both a voxel whose density is equal to or greater than the reference threshold value and a voxel whose density is less than the reference threshold value. Then, a polygon mesh is generated by connecting together adjacent vertices if the connection (the boundary between the regions including the vertices) passes through a voxel whose density is equal to or greater than the reference threshold value and a voxel whose density is less than the reference threshold value. The coordinates of each vertex are determined by comparing densities of adjacent voxels and interpolating based on the difference in density for each of the XYZ axes. In this process, the coordinates can be further calculated based on the normal information. The normal information may be stored in advance for at least some of the voxels, or if not stored, the normal information may also be calculated based on densities between adjacent voxels. Note that in FIG. 14, the density of the voxel 202 is less than the reference threshold value, the voxel 202 is treated as being outside the voxel object in the determination of the presence/absence of a vertex, but the density value itself of the voxel 202 is used to calculate the coordinates of the vertices generated. If the reference threshold value were set to a value lower than the density of the voxel 202, it would result in an increase in the vertices on the upper right side and the upper left side in the voxel 202 of FIG. 14.

By generating a polygon mesh as described above, it is possible to generate a shape whose volume is based on (e.g., reflects) the density of each voxel to some extent. Note however that depending on the relationship with neighboring voxels, it is possible that a voxel with a density of 0 may partially include a region inside the voxel object, or a voxel with a density of 255 may partially include a region outside the voxel object. Since voxels with densities less than the reference threshold value are treated as being outside the voxel object in the exemplary embodiment, there are fewer vertices as compared with a case where those voxels are treated as being inside the voxel object, the volume will be smaller accordingly. That is, there is no need to calculate the polygon mesh so that the volume strictly corresponds to the density value.

FIG. 15 shows an example of a game image including a terrain object. In the exemplary embodiment, by generating a mesh as described above, the voxel object can be made in a shape with complicated irregularities compared to the cubic voxels, for example.

Note that there is no limitation on the method of generating a mesh based on voxel data. For example, in other embodiments, if the density of the voxel data is greater than a predetermined value, a mesh may be generated so that a cube is placed in the voxel (see FIG. 8).

For each face of the mesh generated as described above, the game system 1 determines the appearance (e.g., color and/or pattern) of each such face according to the material identified by the voxel data. Specifically, the game system 1 determines the texture to be used for rendering each face of the mesh based on the voxel data, and maps the determined texture to each face to generate an image of the voxel object. Note that the texture to be mapped to each face of the mesh is determined based on the voxel data of the voxel used to generate the face (which will be referred to as the target voxel) among the voxels where the voxel object exists. Note that the target voxel is, for example, one or more voxels located around the face, although it depends on the mesh generation method. That is, the texture mapped to a face of the mesh is determined to be a texture corresponding to the material set for one or more voxels placed around the face.

Note that in other embodiments, one voxel data may include multiple types (e.g., two types) of material data. In such a case, the voxel data includes ratio data related to the multiple types of material data. The ratio data is data for determining the texture to be used for the voxel object, and represents the ratio by which each of the materials (specifically, the texture corresponding to the material) represented by the multiple types of material data influences the appearance (specifically, the color and/or pattern) of the voxel object. When determining the texture to be mapped to each face of the mesh, the texture is determined based on various data (specifically, density data, multiple types of material data and ratio data) included in the voxel data of the target voxel. For example, when multiple types of materials are set for a target voxel corresponding to one face, a texture corresponding to the (one type of) material with the greatest degree of influence may be used while taking the ratio into consideration, or textures corresponding to multiple types of materials may be used while taking the ratio into consideration.

In other embodiments, there may be both voxel objects for which voxel data including one type of material data is used, and voxel objects for which voxel data including two types of material data is used.

### [2-3. Deformation and Restoration of Terrain Object]

As described above, in the exemplary embodiment, a player (in other words, a user of the game system 1) can perform deformation (e.g., deletion or addition) on a terrain object by operating a player character. That is, the game system 1 changes the shape of the terrain object by deleting the terrain object or making an addition to the terrain object according to a motion of the player character based on an operation input performed by the player. Thus, the player can progress the game while deforming the terrain object through an operation performed to the player character. Note that there is no limitation on the specific content of the motion of the player character for deforming the terrain object. For example, in the exemplary embodiment, the player character can delete (or break) the terrain object by a motion of punching the terrain object. In addition, by throwing a specific object (e.g., an object of the same material as the terrain object) at the terrain object, the player character can add the specific object to the terrain object (e.g., deform the terrain object into a shape having the specific object attached to the terrain object).

Note that the terrain object may not necessarily be deformed by the motion of the player character, and may be deformed by other reasons. For example, the terrain object may be deformed by a character (e.g., an enemy character) other than the player character, or may be automatically deformed according to the lapse of time.

The terrain object may include an object that is not deleted by the motion of the player character. For example, a portion of the terrain object may be an object of a type that is not deleted by a punching motion of the player character. Thus, it is possible to reduce the possibility of inconvenience that the game cannot be further progressed due to excessive deletion of the terrain object (e.g., the player character cannot go to a destination because a road to the destination has been deleted). Further, for example, it is possible to reduce the possibility of inconvenience that the player character goes straight from a start point to a goal point while deleting the terrain object and thereby the player easily clears the game stage. Specifically, the terrain object may be configured such that an undeletable bedrock object is disposed beneath a deletable soil object. In this case, even when the soil object has been deleted, the player character can go along the undeletable bedrock object. Therefore, it is possible to reduce the possibility of inconvenience that the player character falls or cannot go forward because of absence of the soil object. Note that in other embodiments, the terrain object may not include an object that is undeletable by the motion of the player character.

In the exemplary embodiment, during a game in a game stage, the player can reset the terrain object, in the game stage, having been deformed as described above, by performing a terrain resetting input. Hereinafter, terrain reset will be described in detail.

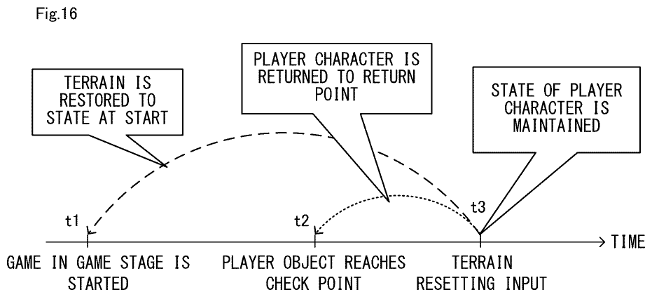

FIG. 16 is a diagram showing an example of change when terrain reset has been performed. FIG. 16 shows a case where, after a game in a certain game stage has been started (time t1), the player character reaches a check point (time t2), and thereafter, a terrain resetting input is performed (time t3).

A “game stage” is a virtual game space in which a terrain object is placed. In the exemplary embodiment, a plurality of game stages have been prepared. When the player character enters a game stage for the first time, the player character is placed at a predetermined start point, and a game is started in the game stage. When the player character has satisfied a clear condition set for the game stage, this means that the player character has cleared the game stage. Note that there is no limitation on the content of the clear condition. For example, the clear condition may be that the player character defeats a boss character that appears in the game stage, that the player character reaches a goal point in the game stage, or that the player character acquires an item disposed in the game stage.

In the exemplary embodiment, a reference state (specifically, a reference shape and a reference material) is predefined regarding the terrain object in the game stage, and the game system 1 has, stored therein, data (specifically, voxel data) representing the reference state. At the time when the game in the game stage has started, the terrain object has a shape in the reference state. It can be said that the reference state is an initial state of the terrain object. However, after the game in the game stage has started, the reference state may be changed (to be described later in detail).

In the exemplary embodiment, one or more check points are set in the game stage. A check point is a reference point for a position (referred to as “return point”) at which the player character is placed when the game is resumed after terrain reset as described above or game over. Specifically, in the case of terrain reset or game over, the player character is placed at a return point near a check point, and the game is resumed.

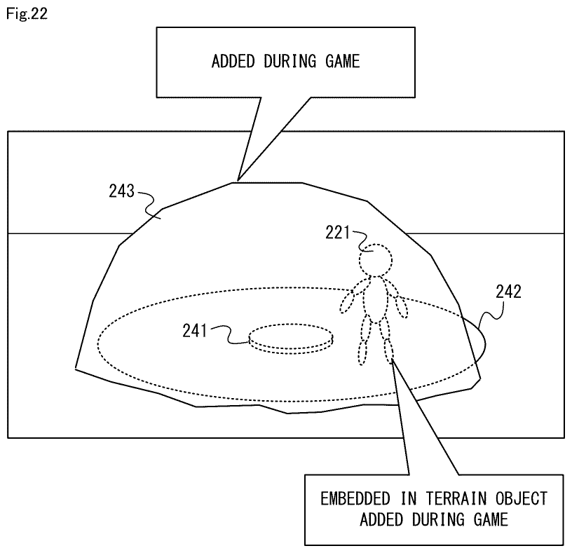

At the check point, an object (e.g., an object 241 shown in FIG. 22 described below) representing the position of the check point is placed. Further, in the game stage, a predetermined range including the check point (e.g., a range within a predetermined distance from the check point) is set as a return area. During the game, the game system 1 determines that the player character has reached the check point, at least on condition that the player character has reached the return area (e.g., has entered the return area). There is no limitation on the specific content of this determination method. For example, the game system 1 may determine that the player character has reached the check point when the player character has just entered the return area, or when the player character has entered the return area and performed a specific motion (e.g., punching motion or the like) on the object.

Upon determining that the player character has reached the check point, the game system 1 sets, as a return point, a position determined based on the return area (e.g., a position in the return area, or a position in the vicinity of the return area). Therefore, once the player character has reached the check point, even if the game is over thereafter, the player character can resume the game not from the start point in the game stage but from the return point that is advanced from the start point. In the exemplary embodiment, in the situation where the player character has not yet reached any of the check points in the game stage after start of the game in the game stage, the start point in the game stage is set as a return point.

In the exemplary embodiment, the player character can immediately move (so-called “fast travel”) to the return point corresponding to an already-reached check point among the check points in the game stage, in response to an instruction of the player during the game. Therefore, in this game, the player character, having reached the check point, can resume the game from the position advanced from the start point, and moreover, can perform the fast travel described above, whereby the game is advantageously progressed.

During the game in the game stage, when the player has performed a terrain resetting input, the game system 1 performs: terrain reset; placement (or movement) of the player character to the return point; and setting of the state of the player character.

As for the terrain reset, the game system 1 changes the terrain object to the reference state described above. That is, the shape of the terrain object, to which deletion or addition has been performed after the start of the game, is restored to the shape at the start of the game through the terrain reset (see FIG. 16).

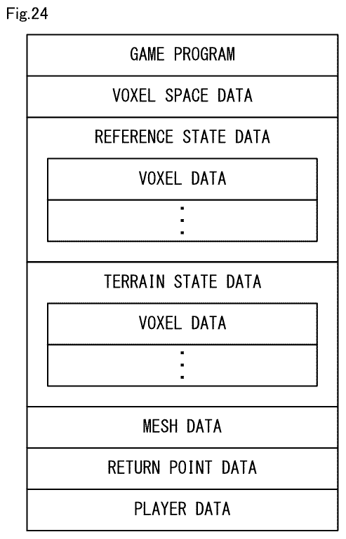

Specifically, the game system 1 has, stored therein in advance, reference terrain information (specifically, reference state data shown in FIG. 24 described later) representing a reference shape of the terrain object in the game stage (e.g., the shape of the terrain object in the reference state). At the time of starting the game in the game stage, the game system 1 generates the terrain object, based on the reference terrain information. Then, when a terrain resetting input has been performed, the game system 1 restores the terrain object whose shape has been changed, based on the reference terrain information. Thus, the terrain reset allows the terrain object to be restored to the shape at the start of the game.

Note that in the exemplary embodiment, basically, deformation of the terrain object performed after the start of the game is not reflected in the reference state. However, deformation of the terrain object performed under a specific condition may be reflected in the reference state. There is no limitation on the content of the specific condition. For example, the specific condition may be that the terrain object is deformed in a specific area in the game stage, or that the terrain object is deformed by a specific motion of the player character (e.g., a motion of using a specific item). For example, if the player character is allowed to build its own house in the game stage, a change in the terrain object in an area where the house can be built, may be reflected in the reference state. Alternatively, the specific condition may be that a specific presentation has been performed according to progress of the story of the game. For example, when the player character has defeated a specific enemy character (e.g., boss character), the terrain object may be deformed through presentation that a dungeon where the enemy character was present collapses. Alternatively, for example, according to presentation that a rock object having dammed up a river is broken, the terrain object may be deformed to allow the river to flow. Each of the changes in the reference state described above can be regarded as a permanent change in the terrain object because the changed terrain object cannot be restored by terrain reset.

Note that when the reference state is changed, the game system 1 may have, stored therein in advance, first data representing the initial state of the terrain object, and second data representing the terrain object in the specific area. The game system 1 may generate a terrain object in the reference state by reflecting the shape of the terrain object (in the area described above) represented by the second data, into the terrain object represented by the first data.

When terrain reset has been performed, the game system 1 places the player character at the return point in the game stage (see FIG. 16). Therefore, after the terrain reset, the game is resumed from the state where the player character is placed at the return point. Therefore, according to the exemplary embodiment, if the player becomes incapable of grasping the position of the player character in the game stage, the terrain resetting input enables the player to again grasp the position of the player character in the game stage, thereby preventing the player character from getting lost.

In the exemplary embodiment, if the player character has already reached a plurality of check points in the game stage, the game system 1 sets, as a return point, a position corresponding to a check point where the player character reached last. That is, when a terrain resetting input has been performed, the game system 1 moves the player character to a return point that was set last, out of the set return points. This allows the player to resume the game from a position where the player can easily progress the game, thereby improving convenience for the player. Note that there is no limitation on the return point determining method. In other embodiments, for example, a position corresponding to a check point selected by the player from among a plurality of already-reached check points may be set as a return point.

As for predetermined types of states regarding the player character placed at the return point by the terrain resetting input, the states immediately before the terrain resetting input are maintained. Specifically, the game system 1 automatically stores therein player information representing the states of the player character during the game, and when the terrain resetting input has been performed, the game system 1 moves the player character to the return point while the predetermined types of states, which correspond to some or all of the states represented by the player information, are maintained.

In the exemplary embodiment, in response to the terrain resetting input, the game system 1 moves the player character to the return point while (a) information representing the progression state of the game (e.g., information representing cleared game stages), (b) information representing hit points of the player character, and (c) information representing the conditions and/or the number of items possessed by the player character, are maintained out of the states represented by the player information. In the exemplary embodiment, an ability value and a level of the player character are maintained, in addition to the states represented by the pieces of information of the above (a) to (c). In other embodiments, the game system 1 may move the player character to the return point while only some of the above pieces of information are maintained. Thus, the player can restore the terrain object while maintaining the states of the player character, whereby convenience of the terrain resetting input can be improved.

Note that in the exemplary embodiment, among the states of the player character, a temporary state is not maintained when the terrain resetting input has been performed. The “temporary state” is a state that is automatically restored according to the lapse of time, for example, a state where the ability of the player character is enhanced only for a predetermined period, or a state where the player character becomes unbeatable only for a predetermined period. That is, in the exemplary embodiment, even if the player character has attained the effect due to the temporary state described above (e.g., even if the ability has been temporarily enhanced) at the time when the terrain resetting input is performed, the effect is lost when the player character is placed at the return point according to the terrain resetting input. In other embodiments, however, when the player character is placed at the return point according to the terrain resetting input, the temporary state may be maintained.

As described above, in the exemplary embodiment, when a terrain resetting input has been performed, the game system 1 restores the terrain object to the reference state, and moves the player character to the return point while maintaining the current states for a predetermined types of states (see FIG. 16). This allows the player to restore the terrain object without significantly wasting the results achieved so far in the game progress. Therefore, according to the exemplary embodiment, convenience in the case of resetting the terrain object can be improved.

In other embodiments, a game in which a plurality of game stages are prepared and a player character sequentially clears the game stages, may be adopted. In such a game, the player character can leave the current game stage (or can move to another game stage), and may also be allowed to play the game in the game stage again from the beginning after the leaving. When the player plays the game in the game stage again from the beginning, the terrain object is restored to the reference state, as in the case where terrain reset is performed. However, when the player character has left the game stage, the state of the player character is restored to the state at the start of the game of the game stage from which the player character left. That is, when the player character has left the game stage without satisfying the clear condition set for the game stage, the game system 1 restores the content of the player information to the content before the player character enters the game stage. Therefore, for a player who desires to restore the terrain object, performing a terrain resetting input is more advantageous than leaving the game stage. In this regard, it can be said that convenience for the player can be improved by the terrain resetting input. Out of the pieces of player information, information to be restored to the content before the player character enters the game stage may be at least one of the information representing the progress state of the game, the information representing the hit points, and the information representing the conditions and/or the number of items. Note that in other embodiments, the game system 1 may prohibit the player character from leaving the current game stage unless satisfying the clear condition.

In the exemplary embodiment, no value is requested in exchange for the terrain resetting input in the game. That is, the game system 1 restores the shape of the terrain object and moves the player character to the return point, according to the terrain resetting input, without consuming any currency and item used in the game. This allows the player to perform the terrain resetting input without or almost without disadvantages in the game, whereby convenience of the terrain resetting input is further improved. Note that in other embodiments, the game system 1 may receive the terrain resetting input performed by the player, in exchange for consuming any value in the game (e.g., in-game currency or item).

In the exemplary embodiment, the game system 1 receives the terrain resetting input regardless of the progress state of the game in the game stage. That is, after start of the game in the game stage, the player can perform the terrain resetting input at any timing without a condition regarding the progress state of the game. For example, the player can perform the terrain resetting input without moving the player character to a specific place or obtaining a specific item in the game stage. Thus, in the exemplary embodiment, the game system 1 restores the shape of the terrain object and moves the player character to the return point, according to the terrain resetting input, regardless of the progress state of the game. Thus, the player can perform the terrain resetting input regardless of the progress state of the game, and therefore can easily perform terrain reset. Note that in other embodiments, the game system 1 may receive the terrain resetting input when the game progress state in the game stage has satisfied a predetermined condition (e.g., when the player character has reached a predetermined check point).

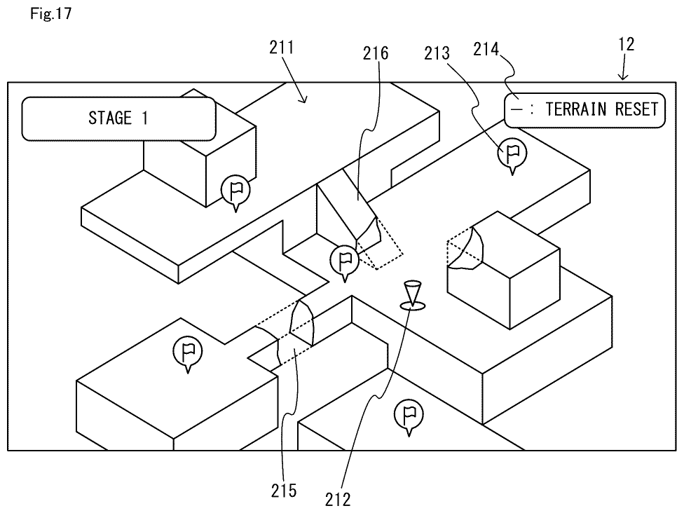

In the exemplary embodiment, the terrain resetting input is received in a state where a map image is displayed during the game. FIG. 17 is a diagram showing an example of a map image displayed on the display device.

As shown in FIG. 17, the map image includes a stage image 211 representing a game stage. In the exemplary embodiment, the game system 1 displays the map image on the display 12 according to an instruction to display a map having been made by the player. In the example shown in FIG. 17, the map image is an image three-dimensionally (in other words, stereoscopically) representing the game stage. However, the map image may be an image two-dimensionally (in other words, planarly) representing the game stage.

In the exemplary embodiment, the stage image 211 represents the shape of a terrain object at the current time. In the example shown in FIG. 17, a portion of a narrow road 215, a portion of a sloped road 216, etc., of the terrain object are deleted. Note that the deleted portions of the terrain object are indicated by dotted lines in the example shown in FIG. 17, but the deleted portions may not necessarily be shown in the stage image. Thus, in the exemplary embodiment, the player can grasp the current state of the terrain object by seeing the map image.

The map image includes: a current position mark 212 representing the current position of the player character in the game stage; and check point marks (e.g., a mark 213) representing check points in the game stage. These marks allow the player to grasp the current position of the player character, and the positions of the check points. Note that, regarding the check point marks, only those representing the check points where the player character has already reached may be displayed, or the display manner for those representing the check points where the player character has already reached may be different from the display manner for those representing the check points where the player character has not yet reached.

As described above, the game system 1 causes the display device to display the map image which represents the game stage and in which change in the shape of the terrain object is reflected. Then, the terrain resetting input is received in the state where the map image is being displayed. This allows the player to determine whether or not to perform a terrain resetting input while checking the current state of the terrain object, whereby convenience for the player can be further improved. Note that in other embodiments, there is no limitation on the timing at which the terrain resetting input is received. For example, the game system 1 may receive the terrain resetting input at a timing when the map image is not displayed.

As shown in FIG. 17, in the exemplary embodiment, the map image includes a guide image 214 representing a terrain resetting input. The guide image 214 indicates an operation for performing a terrain resetting input (here, an operation of pressing a “−” button 47). The guide image 214 allows the player to recognize that he/she can perform a terrain resetting input in the state where the map image is displayed.

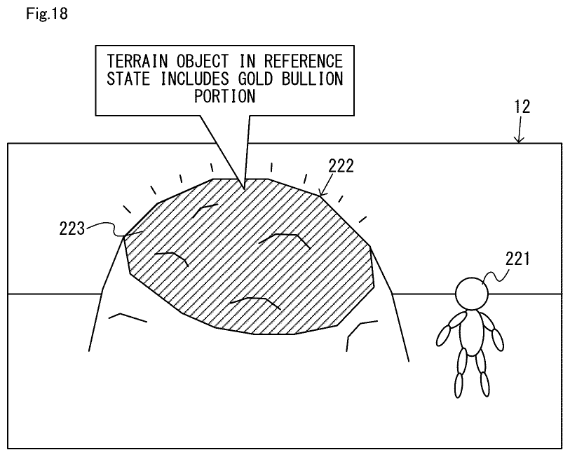

When terrain reset is performed according to the terrain resetting input, the game system 1 may restore the shape of a certain terrain object, but may not necessarily restore the property and the appearance (e.g., the property and the texture of the material described above) of the terrain object. Hereinafter, an example of terrain reset in which the property and the appearance of a terrain object are not restored will be described with reference to FIG. 18 to FIG. 20.

FIG. 18 is a diagram showing an example of a game image representing a terrain object in a reference state. In the example shown in FIG. 18, in the reference state, a terrain object 222 imitating a rock protruding from the ground is arranged in a game stage. The terrain object 222 includes, in addition to a portion having the property of rock, a gold bullion portion having the property of gold bullion (in FIG. 18, a portion indicated by oblique hatching, e.g., an object 223). The property of gold bullion is that the player character can obtain in-game currency when the player character has deleted the gold bullion portion.

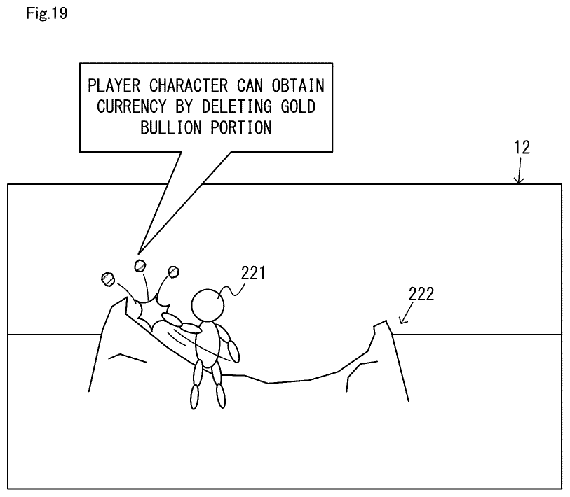

FIG. 19 is a diagram showing an example of a game image representing a state where a portion of the terrain object 222 has been deleted by a player character 221. As shown in FIG. 19, when the player character 221 has deleted the gold bullion portion included in the terrain object 222 during the game, the game system 1 gives, to the player character 221, in-game currency of the quantity corresponding to the deleted gold bullion portion. The player can obtain the in-game currency by deleting the gold bullion portion included in the terrain object in the game stage, and therefore can advantageously advance the game.

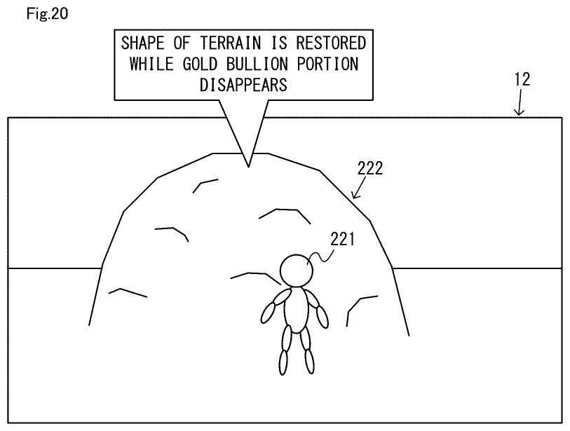

FIG. 20 is a diagram showing an example of a game image representing a state where terrain reset has been performed after the state shown in FIG. 19. As shown in FIG. 20, when the terrain reset has been performed, the terrain object 222 is restored to the shape in the reference state (see FIG. 18). In the exemplary embodiment, the portion, of the terrain object 222, which has been deleted and restored does not include a gold bullion portion (see FIG. 20). That is, the game system 1 restores the shape of the terrain object 222 such that, for the gold bullion portion of the terrain object 222, the property of gold bullion is changed to the property of ordinary rock. Note that the gold bullion portion, of the terrain object 222, which is not deleted remains unchanged even after the restoration due to the terrain reset. Note that in other embodiments, when the terrain reset has been performed, the game system 1 may change the property of the gold bullion portion, which is located near the deleted gold bullion portion and is not deleted, to the property of ordinary rock.

As described above, in the exemplary embodiment, the terrain object includes a first terrain object (e.g., the portion having the property of rock) and a second terrain object (e.g., the portion having the property of gold bullion). According to a terrain resetting input, the game system 1 restores the property and the shape of the first terrain object, and restores the shape of the second terrain object with the property of the second terrain object being changed. This avoids inconvenience resulting from the property of the terrain object being maintained, as described below.

In the example shown in FIG. 18 to FIG. 20, if the terrain object 222 is restored so as to include a gold bullion portion, the player can easily obtain a large quantity of in-game currency by repeating: deletion of the terrain object 222 to obtain in-game currency; and restoration of the terrain object 222 through a terrain resetting input performed after the deletion. This may result in the possibility that the difficulty level of the game is excessively reduced due to the terrain resetting input. Meanwhile, in the exemplary embodiment, as described above, the terrain object 222 is restored such that the property of the terrain object 222 is changed so as not to include a gold bullion portion, whereby the possibility of excessive reduction in the difficulty level of the game is reduced without a limitation on the terrain resetting input itself. That is, in the exemplary embodiment, the possibility of excessive reduction in the difficulty level of the game can be reduced without reduction in convenience of the terrain resetting input. Note that in other embodiments, the game system 1 may restore the shape of the terrain object such that the property of the entire portion of the terrain object to be restored is maintained, or may restore the shape of the terrain object such that the property of the entire portion of the terrain object to be restored is changed.

As described above, in the exemplary embodiment, the property of the second terrain object before being restored by terrain reset is a property that a reward is given to the player character 221 when the second terrain object has been deleted according to a motion of the player character 221 based on an input performed by the player. Then, according to a terrain resetting input, the game system 1 changes the property of the second terrain object to a property that a reward is not given to the player character 221 even when the second terrain object has been deleted according to a motion of the player character 221 based on an input performed by the player (in other embodiments, a property that a reward less than that before the change is given) (see FIG. 20). This reduces the possibility that too much reward is given to the player character 221 due to the terrain resetting input.

Although the reward is in-game currency in the exemplary embodiment, any reward may be given to the player character as long as it is advantageous for the player character in the game. For example, the reward may be an item, or an experience point of the player character.

In the exemplary embodiment, the second terrain object whose property is changed when being restored by terrain reset is determined in advance. That is, the game system 1 regards the terrain object in a predetermined area as the second terrain object, and changes the property of the terrain object in this area when the terrain object is restored by terrain reset, whereas the game system 1 does not change the property of the terrain object outside this area (in other words, the first terrain object) when the terrain object is restored by terrain reset. For example, an area in which gold bullion portions as described above are dense in the reference state is set as the area of the second terrain object. However, not the entire area including the gold bullion portions is necessarily set as the area of the second terrain object.

In the exemplary embodiment, in addition to restoration of the terrain object by the terrain reset according to the terrain resetting input described above, restoration of the terrain object is also performed when the game is over (e.g., when the hit point of the player character becomes 0, or when the player character falls from the terrain object in the game stage). Note that when the game is over, restoration is performed not for the terrain object in the entire game stage but for the terrain object in a target area. Hereinafter, restoration of the terrain object in the target area will be described.

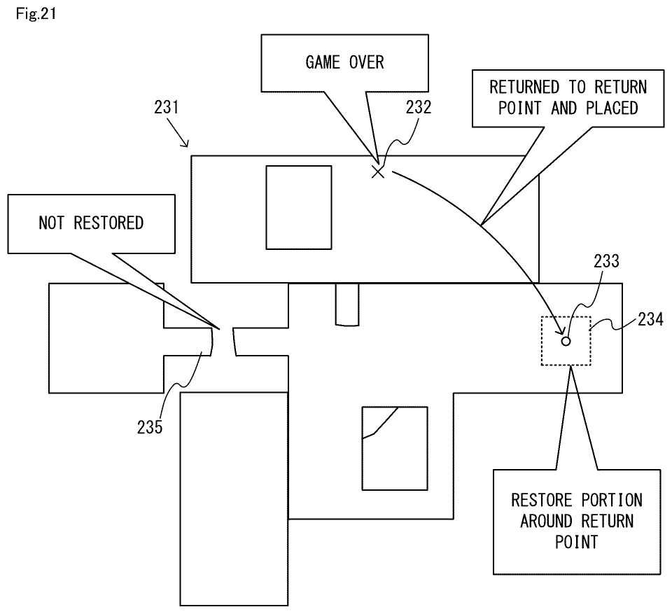

FIG. 21 is a diagram illustrating an outline of restoration of a terrain object in a target area. FIG. 21 shows a case where the game is over when the player character is positioned at a certain point 232 in a game stage 231, and the game is resumed when the player character moves to a return point 233. In this case, the game system 1 sets, as a target area 234, an area around and including the return point 233, and restores a terrain object in the target area 234 to the shape in the reference state. Meanwhile, in the above case, a terrain object outside the target area 234 (e.g., a terrain object 235 which is a narrow road) is not restored.

Next, the reason why an area including a return point is set as a target area will be described. FIG. 22 is a diagram showing an example of a state where a terrain object is added in the vicinity of a check point. FIG. 22 shows a state where after the player character has reached a check point indicated by an object 241, a terrain object 243 is added so as to cover a return area 242 around the check point for some reason (e.g., a motion of the player character itself). Now, a case where the game is over in this state, restoration of the terrain object in the return area 242 to the reference state is not performed, and the added terrain object 243 remains, is considered. In this case, if the game is resumed in the state where the player character 221 is positioned at the return point in the return area 242 because of the game over, the player character 221 is embedded in the terrain object 243 (see FIG. 21). Although not shown in FIG. 22, in the case where the ground in the return area 242 is deleted, if the player character 221 is placed at the return point when the game is resumed after the game over, the player character 221 may fall from the return point at the moment of the placement (because the ground has been deleted).

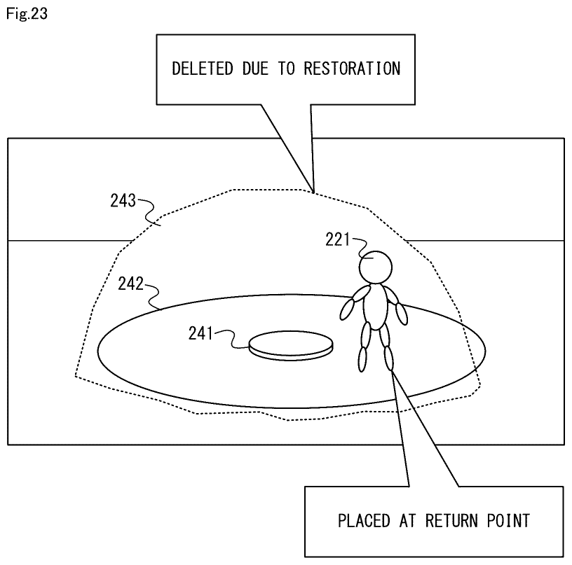

In the exemplary embodiment, when the game is over, the game system 1 sets, as a target area, an area including a return point, and restores a terrain object in the target area to the reference state. FIG. 23 is a diagram showing an example of a state where a terrain object in a target area including a return point is restored. In the example shown in FIG. 23, when the game is over and the player character 221 is placed at the return point, the terrain object 243 added so as to cover the return area 242 is deleted due to restoration. Therefore, the player character 221 is placed without being embedded in the terrain object, whereby the game is normally resumed.

As described above, in the exemplary embodiment, the game system 1 automatically restores the shape of the terrain object in the target area according to an automatic resumption condition (here, game over) having been satisfied, and does not restore the shape of the terrain object outside the target area. Meanwhile, as described above, according to the terrain resetting input, the game system 1 performs restoration of both the terrain object in the target area and the terrain object outside the target area. Therefore, the player can manually restore the terrain object, and the game system 1 automatically restores the terrain object under a certain condition, whereby the possibility of inconvenience in the game can be reduced. Note that in other embodiments, the game system 1 may not perform automatic restoration according to the automatic restoration condition. Further, in other embodiments, the game system 1 may restore the terrain objects in the entire game stage when the automatic restoration condition has been satisfied, as in the case where the terrain resetting input has been performed.

Note that the phrase “automatically restoring a terrain object” can include that the terrain object is restored by the game system 1 even without a terrain resetting input performed by the player, but does not exclude a case where an operation performed by the player has some kind of influence on execution of restoration. For example, in the above example, when the game is over due to an operation of the player, the game system 1 restores the terrain object, and this restoration corresponds to “automatically performing restoration”.

In the example shown in FIG. 21 to FIG. 23, the automatic restoration condition is that the player character has satisfied a game over condition (e.g., the hit point of the player character being 0, the player character falling from the terrain object in the game stage, and the like). The target area includes the return point where the player character is placed after the game over condition is satisfied, and an area surrounding the return point. Thus, it is possible to reduce the possibility of inconvenience at the time of resumption of the game, such as that the player character placed at the return point is embedded in the terrain object or falls due to deformation of the terrain object having been performed so far.

In the case where a plurality of return points are set in the game stage (e.g., the player character has already reached a plurality of check points), the game system 1 may set, as a target area, only an area including a return point to which the player character will move when the game is over, and may not set, as a target area, an area including the other return points. The reason is because no inconvenience will occur at the time of resumption of the game even if restoration of terrain objects is not performed in the area including the other return points.

Note that the target area is not limited to an area around a return point, and may be another area. For example, the target area may be an area where a battle against a boss character that appears in the game stage is performed (this area is referred to as “boss area”). That is, assuming that an automatic restoration condition is that the game is over for the player character during the battle against the boss character, when this automatic restoration condition has been satisfied, the game system 1 may restore the terrain object in the target area, e.g., the boss area.

In the game according to the exemplary embodiment, the player character battles against the boss character by using a terrain object (e.g., throwing the terrain object at the boss character to attack the boss character, or defending against an attack from the boss character by using the terrain object as a shield). Therefore, when the game is resumed after having been over in the state where the terrain object is deformed through the battle against the boss character, if the terrain object is not restored, the terrain object remains deformed when the player character battles against the boss character next time, which may make the battle significantly disadvantageous for the player character. For example, in the case where the player character throws the terrain object at the boss character in the battle, if the terrain object is not restored, the player character has to battle against the boss character without the terrain object to be thrown.

Therefore, in the exemplary embodiment, the boss area is set as a target area, and when the game is over, the terrain object in the boss area is restored. This reduces the possibility of inconvenience that the battle against the boss character becomes significantly disadvantageous for the player character.

In the game stage, an area to be set as a target area is not limited to the above areas, and may be an area as follows. That is, the game system 1 may set, as a target area, an area that is necessary for the player character to go to a destination in the game stage. For example, if the game is over after a road along which the player character has to go to reach the destination has been deleted, the player character cannot pass the road after resumption of the game, which makes it impossible to progress the game. In this case, the game system 1 may set, as a target area, an area including the road. Thus, the game system 1 sets, as a target area, an area that may cause inconvenience in game progress if a terrain object in this area is deleted, thereby reducing the possibility of such inconvenience.

In the exemplary embodiment, the game system 1 manages the target area by using a predetermined unit section. That is, a target area is set for each of unit sections defined in the game stage. A unit section is a section called a chunk having 8 voxels in each of up-down, left-right, and front-rear directions, for example. In the exemplary embodiment, the game system 1 compresses and stores, in units of chunks, voxel data of a terrain object in the reference state. When the game is over, the game system 1 decompresses the compressed voxel data with respect to a unit section (e.g., chunk) corresponding to a target area to obtain the terrain object in the reference state in this target area, and restores the terrain object in the target area. Thus, the game system 1 decompresses the voxel data with respect to only the unit section corresponding to the target area, and therefore can efficiently perform the restoration process. Note that in other embodiments, a target area may be set independently from the unit section.

The automatic restoration condition is not limited to that the game is over, and may be another condition. For example, the automatic restoration condition may be that the player character has performed fast travel as described above. In this case, according to fast travel having been performed, the game system 1 sets, as a target area, an area including a return point corresponding to a check point as a destination, and restores a terrain object in the target area. This reduces the possibility of inconvenience that the player character is embedded in the terrain object when the fast travel is performed.

The automatic restoration condition may be a condition regarding the usage rate of a memory used for game processing, for example. Specifically, the game system 1 may monitor the usage rate of the memory (e.g., the DRAM 85) of the game system 1 (more specifically, the main body apparatus 2), and when the usage rate of the memory becomes equal to or higher than a threshold value, the game system 1 may perform restoration of a terrain object. In this case, since data of the deformed terrain object can be deleted from the memory, the usage rate of the memory can be reduced, and the possibility of trouble in game processing due to memory shortage can be reduced. Note that in the above case, the game system 1 may restore the terrain objects in the entire game stage, or may restore the terrain objects in a certain area in the game stage.

As described above, in the exemplary embodiment, even when a terrain resetting input is not performed, the game system 1 automatically performs restoration of the shape of a terrain object in a predetermined area in the game stage (an area corresponding to a part or the entirety of the game stage), according to the automatic restoration condition having been satisfied (in the exemplary embodiment, game over, or the memory usage rate reaching the threshold value or more). Further, even when a terrain resetting input is not performed, the game system 1 automatically moves the player character to a return point, according to the automatic restoration condition having been satisfied. This reduces the possibility of trouble in game processing or inconvenience in game progress.

In the exemplary embodiment, the game stage may be associated with one or more sub-stages. A sub-stage is a stage that is different from the game stage but is treated as a part of the game stage in the game. For example, when an entrance of a cave or a building is arranged in the game stage, a sub-stage representing the inside of the cave or the building may be prepared. When the player character moves to the entrance of the cave or the building, the player character can move to the sub-stage representing the inside of the cave or the building.

In the exemplary embodiment, when the player character has moved from the game stage to the sub-stage associated with the game stage, the game system 1 stores therein the state of the terrain object in the game stage at that time. Note that in the exemplary embodiment, the game system 1 sequentially stores therein data representing the current state of the terrain object (specifically, terrain state data shown in FIG. 24) during the game in the game stage. When the player character returns to the game stage from the sub-stage (e.g., goes out of the cave or the building), the game system 1 generates a terrain object in the same state as that when the player character moved from the game stage to the sub-stage, by using terrain state data representing the state when the player character moved from the game stage to the sub-stage. Thus, even when the player character has returned from the sub-stage, the shape of the terrain object in the game stage is maintained.

Note that in the exemplary embodiment, when the game is over for the player character in the sub-stage, the game system 1 does not restore the terrain object in the game stage (more specifically, does not restore the terrain object in the target area). The reason is as follows. In the above case, since the game is resumed from a start position in the sub-stage, inconvenience, such as the player character being embedded in the terrain object, does not occur.

Note that in other embodiments, when the player character has returned from the sub-stage, the game system 1 may restore the terrain object in the game stage. Further, in other embodiments, when the game is over for the player character in the sub-stage, the game system 1 may move the player character to the return point in the game stage, and restore the terrain object in the game stage.

### [3. Specific Example of Processing in Game System]

Next, referring to FIG. 24 to FIG. 26, a specific example of information processing in the game system 1 will be described.

FIG. 24 is a diagram showing an example of various data used for the information processing in the game system 1. As shown in FIG. 24, the game system 1 has, stored therein, a game program, voxel space data, reference state data, terrain state data, mesh data, return point data, and player data.

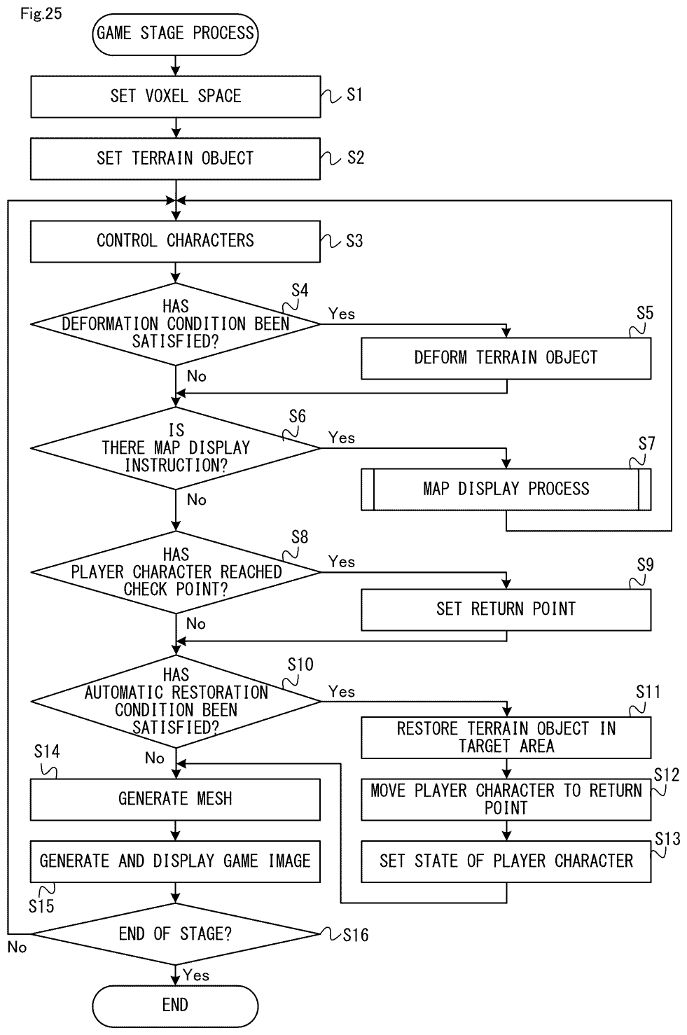

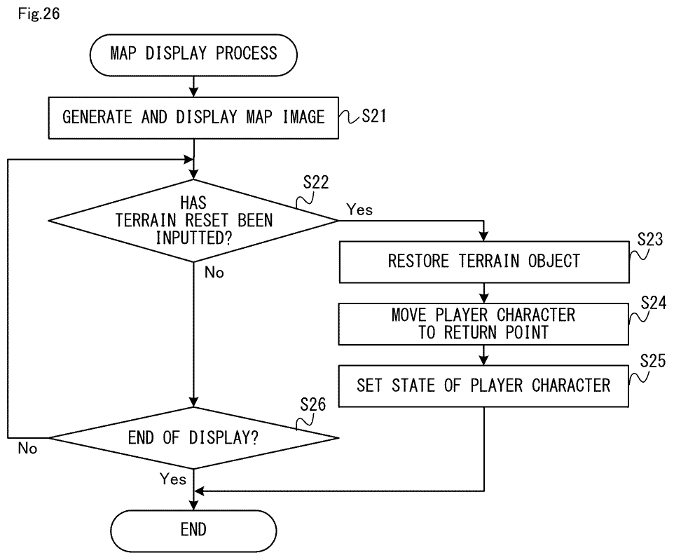

The game program is a game program for executing game processing (specifically, processes shown in FIG. 25 and FIG. 26) in the exemplary embodiment. The game program is data that is stored in the game system 1 in advance of execution of the game processing. The game program is stored in the storage medium attached to the slot 23 of the main body apparatus 2, for example.

The voxel space data is data that defines a voxel space set in a game space (or a game stage). The voxel space data is stored in the storage medium attached to the slot 23 of the main body apparatus 2 together with the game program, for example. The voxel space data represents the length of one side of a voxel, and a direction of each side of a voxel in the game space. If the voxel space is set only in an area corresponding to a part of the game space, the voxel space data may include data representing the position and the size of a space (e.g., a voxel space) in which a voxel is set (e.g., data representing a range, in the game space, in which the voxel is set).

The reference state data is data representing a terrain object in the reference state described above. Specifically, the reference state data includes voxel data indicating the state of each voxel in the reference state. Thus, in the exemplary embodiment, the game system 1 stores therein, as reference state data, data representing the shape and the material (specifically, the property and the appearance) of the terrain object in the reference state. Note that in other embodiments, the game system 1 may store therein, as reference state data, data representing only the shape of the terrain object in the reference state.

The reference state data is prepared in advance (e.g., stored together with the game program, or acquired from an external server or the like). If the reference state data is changed after start of the game, reference state data indicating the changed reference state may be stored in the game system 1 as a part of saved data. When resuming the game by using the saved data, the game system 1 performs game processing by using the reference state data included in the saved data.

The terrain state data represents the state of the current terrain object. Specifically, the terrain state data includes voxel data representing the state of each voxel in the current terrain object. The mesh data is data representing a mesh for a terrain object. The mesh data includes data representing the positions of vertices in the mesh.

The return point data is data representing a return point set in the game stage. Specifically, the return point data is coordinate data representing a position in the game stage. Note that in the case where a plurality of return points are set in the game stage (e.g., the player character has already reached a plurality of check points), the return point data includes data representing each return point.

The player data is data of the above-described player information representing the state of the player character. In the exemplary embodiment, the player data includes: data representing the progress state of the game regarding the player character; data representing the hit points of the player character; and data representing the conditions and/or the number of items possessed by the player character.

In addition to the data shown in FIG. 24, the game system 1 has, stored therein, data regarding objects placed in the game space, data regarding various characters (e.g., enemy characters, etc.) that appear in the game space, and the like.

FIG. 25 is a flowchart showing an example of a flow of a game stage process executed by the game system 1. The game stage process shown in FIG. 25 is a process for executing a game in one game stage, and is started when the game in the game stage has been started (e.g., when the player character has entered the game stage).

In the exemplary embodiment, the processor 81 of the main body apparatus 2 executes the game program stored in the game system 1 to execute processes in steps shown in FIG. 25 and FIG. 26. However, in other embodiments, a part of the processes in the steps may be executed by a processor (e.g., a dedicated circuit or the like) other than the processor 81. Further, if the game system 1 is communicable with another information processing apparatus (e.g., a server), a part of the processes in the steps shown in FIG. 25 and FIG. 26 may be executed by the another information processing apparatus. The processes in the steps shown in FIG. 25 and FIG. 26 are merely examples, and the processing order of the steps may be changed or another process may be executed in addition to (or instead of) the processes in the steps as long as similar results can be obtained.

The processor 81 executes the processes in the steps shown in FIG. 25 and FIG. 26 by using a memory (e.g., the DRAM 85). That is, the processor 81 stores information (in other words, data) obtained in each process step, into the memory, and reads out the information from the memory when using the information for the subsequent process steps.

In step S1 shown in FIG. 25, the processor 81 sets a voxel space in the game space. Specifically, the processor 81 acquires the voxel space data described above, and stores (in other words, writes) the data in the memory. In the subsequent game processing, the processor 81 may sometimes refer to the voxel space data when executing a process regarding a voxel object (e.g., the process in step S2). In this case, the processor 81 refers to the voxel space data stored in the memory. Next to step S1, the process in step S2 is executed.

In step S2, the processor 81 sets, in the game space, a terrain object in a reference state. Specifically, the processor 81 acquires the reference state data described above, and stores (in other words, writes) a part or the entirety of voxel data included in the acquired reference state data into the memory as terrain state data. Note that acquisition of the reference state data may be performed by acquiring data that is prepared in advance (e.g., stored together with the game program, or acquired from an external server or the like), or may be performed by acquiring the reference state data included in the saved data. Next to step S2, the process in step S3 is executed.

In step S3, the processor 81 controls the motions of the characters (specifically, the player character and an enemy character) that appear in the game space. For example, the processor 81 controls the motion of the player character, based on an operation input indicated by operation data received from the controller 3 or 4, and controls the motion of an enemy character, based on an algorithm defined in the game program. In the exemplary embodiment, the progress state of the game (e.g., the states and the like of each character that appears in the game space and each object placed in the game space) is updated through the process in step S3. Further, if the state of the player character has changed as a result of the motion control described above, the processor 81 stores, in the memory, player data representing the state after the change. Thus, in the exemplary embodiment, the processor 81 automatically stores therein player data that changes according to the progress state of the game. Next to step S3, the process in step S4 is executed.

In step S4, the processor 81 determines whether or not a deformation condition for a terrain object has been satisfied as a result of the motions of the respective characters according to the process in step S3. For example, the processor 81 determines that the deformation condition has been satisfied, when a character has performed a predetermined motion on the terrain object (e.g., when the player character has punched the terrain object), or when a specific object (e.g., an object having the same material as the terrain object) has been attached to the terrain object. On the other hand, the processor 81 determines that the deformation condition is not satisfied, when a predetermined motion by a character is not performed on the terrain object, and an object having the same material as the terrain object is not attached to the terrain object. When the determination result in step S4 is positive, the process in step S5 is executed. When the determination result in step S4 is negative, the process in step S5 is skipped, and the process in step S6 is executed.

In step S5, the processor 81 deforms the terrain object. For example, when a character has performed a predetermined motion on the terrain object (e.g., when the player character has punched the terrain object), the processor 81 deforms the terrain object so as to delete a part of the terrain object. Further, for example, when the specific object has been attached to the terrain object, the processor 81 deforms the terrain object into a shape having the specific object attached to the terrain object. In this case, the processor 81 updates the terrain state data stored in the memory so as to represent the state after the change. Next to step S5, the process in step S6 is executed.

In step S6, the processor 81 determines whether or not an instruction to display a map has been made by the player, based on the operation data received from the controller 3 or 4. When the determination result in step S6 is positive, the process in step S7 is executed. When the determination result in step S6 is negative, the process in step S8 is executed.

In step S7, the processor 81 executes a map display process. The map display process is a process for displaying the map image described above (see FIG. 17). The map display process will be described later in detail (see FIG. 26). Next to step S7, the process in step S3 is executed again.

In step S8, the processor 81 determines whether or not the player character has reached a check point as a result of the motions of the respective characters according to the process in step S3. When the determination result in step S8 is positive, the process in step S9 is executed. When the determination result in step S8 is negative, the process in step S9 is skipped and the process in step S10 is executed.

In step S9, the processor 81 sets, as a return point, a position corresponding to the check point where the player character has newly reached. That is, the processor 81 updates the return point data stored in the memory so as to include data representing the set return point. Next to step S9, the process in step S10 is executed.

In step S10, the processor 81 determines whether or not the automatic restoration condition described above has been satisfied as a result of the motions of the respective characters according to the process in step S3. The processor 81 determines that the automatic restoration condition has been satisfied, when the game is over for the player character, or when the player character has performed fast travel, for example. Further, the processor 81 monitors the usage rate of the memory, and determines that the automatic restoration condition has been satisfied, when the usage rate of the memory becomes equal to or higher than a threshold value. When the determination result in step S10 is positive, the process in step S11 is executed. When the determination result in step S10 is negative, the processes in steps S11 to S13 are skipped, and the process in step S14 described later is executed.

In step S11, the processor 81 restores a portion, of the terrain object, in the target area described above. Specifically, the processor 81 acquires, from the memory, the reference state data regarding the portion, of the terrain object, in the target area, and changes the terrain object in the target area into the state represented by the reference state data. That is, the processor 81 updates the terrain state data stored in the memory so as to represent the content after the change. Note that as described in the above “[2-3. Deformation and restoration of terrain object]”, the target area may vary depending on the content of the automatic restoration condition that is determined in step S10 to have been satisfied. For example, when the automatic restoration condition has been satisfied due to game over, an area including the return point and the boss area described above are target areas. For example, when the automatic restoration condition has been satisfied due to the usage rate of the memory reaching the threshold value or more, the entire area of the game stage is a target area. Next to step S11, the process in step S12 is executed.

In step S12, the processor 81 moves the player character to the return point. That is, the processor 81 refers to the return point data stored in the memory, and places the player character at the return point that was set last. Next to step S12, the process in step S13 is executed.

In step S13, the processor 81 sets the state of the player character. That is, the processor 81 sets the state of the player character so as to maintain at least the predetermined state described above (e.g., the information representing the progression status of the game, the information representing the hit points, and the information regarding the items). Note that if the state of the player character is partially changed, the processor 81 updates the player data stored in the memory so as to represent the state after the change. Next to step S13, the process in step S14 is executed.

In step S14, the processor 81 generates a mesh for the terrain object. The mesh for the terrain object is generated according to the method described in the above “[2-2. Mesh]”. Note that in step S14, the processor 81 need not again generate a mesh that has already been generated in the previous process in step S14, and may again generate a mesh for the portion, of the terrain object, in which the voxel data has been changed through the process in step S5 or S11. By the process in step S14, the mesh for the terrain object can be dynamically changed during the game. Note that the processor 81 updates the mesh data stored in the memory to the content indicating the newly generated mesh. Next to step S14, the process in step S15 is executed.

In step S15, the processor 81 generates a game image representing a game space, and causes the display device (e.g., the display 12) to display the game image. Specifically, the processor 81 generates a game image that represents a game space including the terrain object and the other objects (specifically, the player character, etc.). Note that the image of the terrain object is generated according to the method described in the above “[2-2. Mesh]” by using the terrain state data and the mesh data stored in the memory. Further, the processor 81 generates the game image so as to represent the result of the motions of the respective characters through the process in step S3. Note that the game image may be generated including the player character, or may be an image as viewed from the viewpoint of the player character (e.g., an image not including the player character itself). The processor 81 causes the display device to display the game image generated as described above. Note that during the game, the process in step S15 is repeatedly executed once every predetermined time (e.g., 1 frame time). Next to step S15, the process in step S16 is executed.

In step S16, the processor 81 determines whether or not to end the game in the game stage. For example, the processor 81 determines to end the game in the game stage, when an instruction to leave the game stage has been made by the player, when an instruction to end the game has been made by the player, or when the player character has cleared the game stage. When the determination result in step S16 is negative, the process in step S3 is executed again. Thereafter, a series of processes in steps S3 to S16 is repeated until the processor 81 determines to end the game in the game stage in step S16. When the determination result in step S16 is positive, the processor 81 ends the game stage process shown in FIG. 25.

FIG. 26 is a sub-flowchart showing an example of the flow of the map display process shown in FIG. 25. In step S21 shown in FIG. 26, the processor 81 generates a map image and causes the display device (e.g., the display 12) to display the map image. Specifically, the processor 81 generates a map image representing the current state of the terrain object, based on the terrain state data stored in the memory. Next to step S21, the process in step S22 is executed.

In step S22, the processor 81 determines whether or not a terrain resetting input as described above has been performed by the player, based on the operation data received from the controller 3 or 4. When the determination result in step S22 is positive, the process in step S23 is executed. When the determination result in step S22 is negative, the process in step S26 described later is executed.

In step S23, the processor 81 restores the terrain object. Specifically, the processor 81 reads out the reference state data from the memory, and changes the terrain object in the entire game stage to the state represented by the reference state data. That is, the processor 81 updates the terrain state data stored in the memory so as to represent the content after the change. Next to step S23, the process in step S24 is executed.

In step S24, the processor 81 moves the player character to the return point. The process in step S24 is the same as the process in step S12. Next to step S24, the process in step S25 is executed.

In step S25, the processor 81 sets the state of the player character. The process in step S25 is the same as the process in step S13. After step S25, the processor 81 ends the map display process shown in FIG. 26. Thereafter, the processor 81 returns to the game stage process shown in FIG. 25, and executes the process in step S3 again.

In step S26, the processor 81 determines whether or not to end display of the map image. Specifically, the processor 81 determines whether or not an instruction to end display of the map image has been made by the player. When the determination result in step S26 is negative, the process in step S22 is executed again. When the determination result in step S26 is positive, the processor 81 ends the map display process shown in FIG. 26.

### 4. Functions and Effects of Exemplary Embodiment, and Modifications

As described above, in the exemplary embodiment, an information processing program (e.g., the game program) executed in a computer (e.g., the processor 81) of an information processing apparatus (e.g., the main body apparatus 2) causes the computer to function as the following means.
Game control means that updates a progress state of a game that is progressed by controlling a player object (e.g., the player character 221) according to an operation input performed by a player, in a game stage in a virtual space (step S3).
Storage control means that automatically stores, in a storage medium, player information that is associated with the player object and changes according to the progress state of the game (step S3).
Return point setting means that sets, as a return point, a position inside or in the vicinity of a return area in the game stage, based on at least the player object having reached the return area (step S9).
Terrain change means that changes a shape of a terrain object in the game stage according to a motion, of the player object, based on a first operation input performed by the player (step S5).
Terrain restoration means that, according to a second operation input performed by the player, restores the terrain object whose shape has been changed, to the shape (e.g., the shape in a reference state) before the change and before timing at which the return point was set (step S23).
Object moving means that, according to the second operation input, moves the player object to the return point in a state where at least a part of states represented by the player information is maintained (steps S24 and S25).

According to the above configuration, when the terrain object is restored according to the second operation input performed by the player, at least a part of the state of the player object which changes according to the progress state of the game is maintained. Therefore, convenience in the case of resetting the terrain object can be improved. Further, when the terrain object is restored according to the second operation input performed by the player, the player object is moved to the return point. Therefore, the player can again grasp the position of the player object in the game stage, thereby preventing the player object from getting lost.

The “progress state of the game” may be any information that changes according to the progress of the game. Examples of the information include hit points, experience points, the number and types of possessed items, defeated enemies, level, cleared stages, etc., regarding the player character.

In the exemplary embodiment, it can also be said that the information processing program (e.g., the game program) executed in the computer (e.g., the processor 81) of the information processing apparatus (e.g., the main body apparatus 2) causes the computer to function as the following means.
Terrain change means that changes a shape of a terrain object in a game stage according to a motion of a player object (e.g., the player character 221) based on an operation input performed by a player (step S5).
Return point setting means that sets, as a return point, a position inside or in the vicinity of a return area in the game stage, based on at least the player object having reached the return area (step S9).
Restoration means that, according to a restoration condition having been satisfied (e.g., game over, or fast travel having been performed), restores a terrain object, in a predetermined area, whose shape has been changed, to the shape before the change and before timing at which the return point was set (step S11) (note that the restoration means may not necessarily restore a terrain object outside the predetermined area).
Object moving means that moves the player object to the return point according to the restoration (step S12).

According to the above configuration, it is possible to reduce the possibility of inconvenience (e.g., the player object being embedded in the terrain object, or the game progress being disabled) when the player object is moved to the return point and the game is resumed. Note that in the above configuration, there is no limitation on the state of the player object moved to the return point, and the state of the player object before being moved to the return point may not necessarily be maintained.

In the above exemplary embodiment, the terrain object is a voxel object. However, the terrain object may not necessarily be a voxel object. The terrain object may include, in addition to the ground of the game stage, objects such as a floor, a wall, and a ceiling of a building arranged in the game stage.

In the above exemplary embodiment, when a process is executed by using data (including a program) in a certain information processing apparatus, a part of the data required for the process may be transmitted from another information processing apparatus different from the certain information processing apparatus. In this case, the certain information processing apparatus may execute the process by using the data received from the another information processing apparatus and the data stored therein.

In other embodiments, the information processing system may not include some of the components in the above embodiment, and may not execute some of the processes executed in the above embodiment. For example, in order to achieve a specific effect of a part of the above embodiment, the information processing system includes a configuration for achieving the effect and executes a process for achieving the effect, and need not include other configurations and need not execute other processes.

The above exemplary embodiment can be used as, for example, a game system and a game program for the purpose of improving convenience in the case of resetting a terrain object.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable storage medium having stored therein instructions that, when executed, cause one or more processors of an information processing apparatus to execute information processing comprising:
updating a progress state of a game that is progressed by controlling a player object according to an operation input performed by a player in a game stage in a virtual space;
automatically storing, in a storage medium, player information that is associated with the player object and changes according to the progress state of the game;
setting, as a return point, a position inside or in the vicinity of a return area in the game stage, based on at least the player object having reached the return area;
changing a shape of a terrain object in the game stage according to a motion, of the player object, based on a first operation input performed by the player;
according to a second operation input performed by the player, restoring the terrain object whose shape has been changed, to the shape before the change and before timing at which the return point was set; and
according to the second operation input, moving the player object to the return point in a state where at least a part of states represented by the player information is maintained.

2. The non-transitory computer-readable storage medium according to claim 1, wherein the information processing further comprises:
at start of the game in the game stage, generating the terrain object, based on reference terrain information representing a reference shape of the terrain object in the game stage; and
according to the second operation input, restoring the shape of the terrain object having been changed, based on the reference terrain information.

3. The non-transitory computer-readable storage medium according to claim 1, wherein
restoration of the shape of the terrain object and movement of the player object to the return point are performed according to the second operation input without consuming any currency and item used in the game.

4. The non-transitory computer-readable storage medium according to claim 1, wherein
restoration of the shape of the terrain object and movement of the player object to the return point are performed according to the second operation input, regardless of the progress state of the game.

5. The non-transitory computer-readable storage medium according to claim 1, wherein
according to the second operation input, the player object is moved to the return point, in a state where at least one of: information representing the progress state of the game; information representing hit points of the player object; and information representing conditions and/or the number of items possessed by the player object, is maintained among the states represented by the player information.

6. The non-transitory computer-readable storage medium according to claim 1, wherein
the shape of the terrain object is changed by deleting the terrain object or making an addition to the terrain object, according to the motion of the player object based on the first operation input.

7. The non-transitory computer-readable storage medium according to claim 1, wherein
the terrain object includes an object that is not deleted by the motion of the player object based on the first operation input.

8. The non-transitory computer-readable storage medium according to claim 1, wherein
according to the second operation input, the player object is moved to a return point that has been set last, among set return points.

9. The non-transitory computer-readable storage medium according to claim 1, wherein
the terrain object includes a first terrain object and a second terrain object, and
according to the second operation input, a property and a shape of the first terrain object are restored, and a shape of the second terrain object is restored with a property thereof being changed.

10. The non-transitory computer-readable storage medium according to claim 9, wherein
the property of the second terrain object before the restoration is performed is that a reward is given to the player object when the second terrain object is deleted according to a motion of the player object based on the first operation input, and
according to the second operation input, the property of the second terrain object is changed to: a property that a reward is not given to the player object even when the second terrain object is deleted according to the motion of the player object based on the first operation input; or a property that a reward less than that before the change is given to the player object when the second terrain object is deleted according to the motion of the player object based on the first operation input.

11. The non-transitory computer-readable storage medium according to claim 1, wherein
according to an automatic restoration condition having been satisfied, the shape of the terrain object in a predetermined area in the game stage is automatically restored even when the second operation input is not performed, and
according to the automatic restoration condition having been satisfied, the player object is automatically moved to the return point even when the second operation input is not performed.

12. The non-transitory computer-readable storage medium according to claim 11, wherein
according to the automatic restoration condition having been satisfied, the shape of the terrain object in the predetermined area is automatically restored, while the shape of the terrain object outside the predetermined area is not restored, and
according to the second operation input, both the shape of the terrain object inside the predetermined area and the shape of the terrain object outside the predetermined area are restored.

13. The non-transitory computer-readable storage medium according to claim 12, wherein
the automatic restoration condition is that the player object has satisfied a game over condition, and
the predetermined area includes: the return point at which the player object is placed after the player object has satisfied the game over condition; and an area surrounding the return point.

14. The non-transitory computer-readable storage medium according to claim 12, wherein
the automatic restoration condition is that the player object has satisfied a game over condition during a battle against a predetermined enemy object, and
the predetermined area includes an area, in the game stage, in which the battle against the enemy object is performed.

15. The non-transitory computer-readable storage medium according to claim 12, wherein
the predetermined area is set for each of unit sections defined in the game stage.

16. The non-transitory computer-readable storage medium according to claim 11, wherein the information processing further comprises:
monitoring a usage rate of a memory of the information processing apparatus, wherein
the automatic restoration condition is a condition regarding the usage rate of the memory.

17. The non-transitory computer-readable storage medium according to claim 1, wherein the information processing further comprises:
causing a display device to display a map image which represents the game stage and in which change in the shape is reflected; and
receiving the second operation input in a state where the map image is being displayed.

18. The non-transitory computer-readable storage medium according to claim 1, wherein
when the player object has left the game stage without satisfying a clear condition set for the game stage, a content of at least a part of the player information is restored to the content before the player object enters the game stage.

19. An information processing system, comprising one or more processors that are configured to execute information processing comprising:
updating a progress state of a game that is progressed by controlling a player object according to an operation input performed by a player in a game stage in a virtual space;
automatically storing, in a storage medium, player information that is associated with the player object and changes according to the progress state of the game;
setting, as a return point, a position inside or in the vicinity of a return area in the game stage, based on at least the player object having reached the return area;
changing a shape of a terrain object in the game stage according to a motion, of the player object, based on a first operation input performed by the player;
according to a second operation input performed by the player, restoring the terrain object whose shape has been changed, to the shape before the change and before timing at which the return point was set; and
according to the second operation input, moving the player object to the return point in a state where at least a part of states represented by the player information is maintained.

20. An information processing apparatus, comprising one or more processors that are configured to execute information processing comprising:
updating a progress state of a game that is progressed by controlling a player object according to an operation input performed by a player in a game stage in a virtual space;
automatically storing, in a storage medium, player information that is associated with the player object and changes according to the progress state of the game;
setting, as a return point, a position inside or in the vicinity of a return area in the game stage, based on at least the player object having reached the return area;
changing a shape of a terrain object in the game stage according to a motion, of the player object, based on a first operation input performed by the player;
according to a second operation input performed by the player, restoring the terrain object whose shape has been changed, to the shape before the change and before timing at which the return point was set; and
according to the second operation input, moving the player object to the return point in a state where at least a part of states represented by the player information is maintained.

21. An information processing method performed on an information processing system, the information processing method comprising:
updating a progress state of a game that is progressed by controlling a player object according to an operation input performed by a player in a game stage in a virtual space;
automatically storing, in a storage medium, player information that is associated with the player object and changes according to the progress state of the game;
setting, as a return point, a position inside or in the vicinity of a return area in the game stage, based on at least the player object having reached the return area;
changing a shape of a terrain object in the game stage according to a motion, of the player object, based on a first operation input performed by the player;
according to a second operation input performed by the player, restoring the terrain object whose shape has been changed, to the shape before the change and before timing at which the return point was set; and
according to the second operation input, moving the player object to the return point in a state where at least a part of states represented by the player information is maintained.
